(19) United States
(12) Patent Application Publication
(10) Pub. No.: US 2025/0377520 A1
(43) Pub. Date: Dec. 11, 2025

(54) OPTICAL IMAGING LENS ASSEMBLY

(71) Applicant: ZHEJIANG SUNNY OPTICS CO., LTD, Zhejiang (CN)

(72) Inventors: Leilei FU, Zhejiang (CN); Huwei XU, Zhejiang (CN); Qi CHEN, Zhejiang (CN); Jianke WENREN, Zhejiang (CN); Fujian DAI, Zhejiang (CN)

(73) Assignee: ZHEJIANG SUNNY OPTICS CO., LTD, Zhejiang (CN)

(21) Appl. No.: 18/978,802

(22) Filed: Dec. 12, 2024

(30) Foreign Application Priority Data
Jun. 11, 2024 (CN) 202410751127.0

(51) Int. Cl. G02B 9/62; G02B 3/00

(52) U.S. Cl. CPC G02B 9/62; G02B 3/005

(57) ABSTRACT

An optical imaging lens assembly is provided, including a first and second lens barrels, a first lens group, a negative second lens group, and a spacing piece group. The spacing piece group comprises a fourth and fifth spacing piece. The second lens group comprises a positive fourth lens, a negative fifth lens and a negative sixth lens. A combined focal length f456 of the fourth, fifth and sixth lenses, an inner diameter d4s of object-side surface of the fourth spacing piece, and an inner diameter d5s of object-side surface of the fifth spacing piece satisfy: −1.1<(d4s+d5s)/f456<0. An air spacing T45 between the fourth and fifth lenses on the optical axis, an air spacing T56 between the fifth and sixth lenses on the optical axis, a maximal thickness CP4 of the fourth spacing piece, and a maximal thickness CP5 of the fifth spacing piece satisfy: 0.2<CP4/T45−CP5/T56<0.8.

### CROSS-REFERENCE TO RELATED APPLICATIONS

This application claims the priority from Chinese Patent Application No. 202410751127.0, filed in the National Intellectual Property Administration (CNIPA) on Jun. 11, 2024, the contents of which are hereby incorporated by reference in their entirety.

### TECHNICAL FIELD

The present disclosure relates to the field of optical devices, and particularly to an optical imaging lens assembly having six lenses.

### BACKGROUND

In recent years, with the ever-changing consumer demands, the requirements on optical imaging lens assemblies gradually become more complex and diversified. In different application scenarios, the performances of the optical imaging lens assemblies are not the same.

An optical imaging lens assembly having six lenses has become the mainstream, and is widely applied in the fields of mobile phones, security, automobiles, drones, etc. The lens at a rear end has a great influence on the overall imaging of the optical imaging lens assembly having the six lenses. However, for the optical imaging lens assembly having the six lenses, the structural setting of the lens at the rear end is unreasonable, which will cause the lens at the rear end to have the problems of high surface-type sensitivity and easy deformation, thereby affecting the performance of the optical imaging lens assembly.

### SUMMARY

An aspect of the present disclosure provides an optical imaging lens assembly. The optical imaging lens assembly includes a lens barrel assembly, an optical lens group, and a spacing piece group. The optical lens group includes a first lens group and a second lens group, the second lens group having negative refractive power, wherein the first lens group and the second lens group are sequentially arranged along an optical axis from an object side to an image side, the first lens group comprises a first lens, a second lens and a third lens, and the second lens group comprises a fourth lens having positive refractive power, a fifth lens having negative refractive power, and a sixth lens having negative refractive power. The spacing piece group includes a fourth spacing piece placed on an image-side surface of the fourth lens and in contact with the image-side surface of the fourth lens, and a fifth spacing piece placed on an image-side surface of the fifth lens and in contact with the image-side surface of the fifth lens. The lens barrel assembly includes a first lens barrel and a second lens barrel, wherein the first lens group is placed in the first lens barrel, and the second lens group, the fourth spacing piece and the fifth spacing piece are placed in the second lens barrel. The number of lenses having refractive power in the optical imaging lens assembly is six. The combined focal length f456 of the fourth lens, the fifth lens and the sixth lens, an inner diameter d4s of an object-side surface of the fourth spacing piece, and an inner diameter d5s of an object-side surface of the fifth spacing piece satisfy −1.1<(d4s+d5s)/f456<0; The air spacing T45 between the fourth lens and the fifth lens on the optical axis, an air spacing T56 between the fifth lens and the sixth lens on the optical axis, a maximal thickness CP4 of the fourth spacing piece, and a maximal thickness CP5 of the fifth spacing piece satisfy: 0.2<CP4/T45−CP5/T56<0.8.

According to an implementation of the present disclosure, an effective aperture DT41 of an object-side surface of the fourth lens, an effective aperture DT62 of an image-side surface of the sixth lens, an inner diameter d02s of an object-side end surface of the second lens barrel, and an inner diameter d02m of an image-side end surface of the second lens barrel satisfy: −0.3<d02s/DT41−d02m/DT62<0.

According to an implementation of the present disclosure, a radius of curvature R6 of an image-side surface of the third lens, a radius of curvature R7 of an object-side surface of the fourth lens, an inner diameter d01m of an image-side end surface of the first lens barrel, and an inner diameter d02s of an object-side end surface of the second lens barrel satisfy: −0.3<d01m/R6−d02s/R7<0.3.

According to an implementation of the present disclosure, a center thickness CT5 of the fifth lens on the optical axis, a refractive index N5 of the fifth lens, an inner diameter d4m of an image-side surface of the fourth spacing piece, and an inner diameter d5m of an image-side surface of the fifth spacing piece satisfy: 0.2<(d4m-d5m)/CT5×N5<0.8.

According to an implementation of the present disclosure, an axial distance SAG51 from an intersection point of an object-side surface of the fifth lens and the optical axis to a projection point of an effective semi-aperture vertex of the object-side surface of the fifth lens onto the optical axis, an axial distance SAG52 from an intersection point of the image-side surface of the fifth lens and the optical axis to a projection point of an effective semi-aperture vertex of the image-side surface of the fifth lens onto the optical axis, and a spacing EP45 between the fourth spacing piece and the fifth spacing piece along the optical axis satisfy: 2<EP45/(SAG51+SAG52)<5.

According to an implementation of the present disclosure, a combined focal length f123 of the first lens, the second lens and the third lens, the combined focal length f456 of the fourth lens, the fifth lens and the sixth lens, a length L1 of the first lens barrel along a direction of the optical axis, and a length L2 of the second lens barrel along the direction of the optical axis satisfy: −2<f123/L1+f456/L2<−0.8.

According to an implementation of the present disclosure, the spacing piece group further comprises a first spacing piece placed on an image-side surface of the first lens and in contact with the image-side surface of the first lens, where an effective focal length f1 of the first lens, an abbe number V1 of the first lens, an inner diameter d01s of an object-side end surface of the first lens barrel, and an inner diameter d1s of an object-side surface of the first spacing piece satisfy: 4<(d01s−d1s)/f1×V1<8.

According to an implementation of the present disclosure, the spacing piece group further comprises a first spacing piece placed on an image-side surface of the first lens and in contact with the image-side surface of the first lens, where an effective aperture DT12 of the image-side surface of the first lens, an inner diameter d1s of an object-side surface of the first spacing piece, and an outer diameter D1s of the object-side surface of the first spacing piece satisfy: 0<(D1s−d1s)/DT12<0.3.

According to an implementation of the present disclosure, the spacing piece group further comprises a first spacing piece and a first auxiliary spacing piece, where the first spacing piece is placed on an image-side surface of the first lens and in contact with the image-side surface of the first lens, and the first auxiliary spacing piece is placed on an image-side surface of the first spacing piece and in contact with the image-side surface of the first spacing piece, where an air spacing T12 between the first lens and the second lens on the optical axis, a maximal thickness CP1 of the first spacing piece, and a maximal thickness CP1b of the first auxiliary spacing piece satisfy: 0.5<(CP1+CP1b)/T12<2.5.

According to an implementation of the present disclosure, the spacing piece group further comprises a second spacing piece, the second spacing piece is placed on an image-side surface of the second lens and in contact with the image-side surface of the second lens, and an effective aperture DT22 of the image-side surface of the second lens, an effective aperture DT31 of an object-side surface of the third lens, an inner diameter d2s of an object-side surface of the second spacing piece, and an inner diameter d2m of an image-side surface of the second spacing piece satisfy: −0.1<d2m/DT31−d2s/DT22<0.1.

According to an implementation of the present disclosure, the spacing piece group further comprises a first spacing piece and a second spacing piece, the first spacing piece is placed on an image-side surface of the first lens and in contact with the image-side surface of the first lens, and the second spacing piece is placed on an image-side surface of the second lens and in contact with the image-side surface of the second lens, and an axial distance SAG21 from an intersection point of an object-side surface of the second lens and the optical axis to a projection point of an effective semi-aperture vertex of the object-side surface of the second lens onto the optical axis, an axial distance SAG22 from an intersection point of the image-side surface of the second lens and the optical axis to a projection point of an effective semi-aperture vertex of the image-side surface of the second lens onto the optical axis, and a spacing EP12 between the first spacing piece and the second spacing piece along the optical axis satisfy: 1<EP12/(SAG21+SAG22)<2.

According to an implementation of the present disclosure, the spacing piece group further comprises a first spacing piece and a second spacing piece, the first spacing piece is placed on an image-side surface of the first lens and in contact with the image-side surface of the first lens, and the second spacing piece is placed on an image-side surface of the second lens and in contact with the image-side surface of the second lens, where a spacing EP01 between an object-side end surface of the first lens barrel and the first spacing piece along the optical axis, a spacing EP12 between the first spacing piece and the second spacing piece along the optical axis, an effective focal length f1 of the first lens, and an effective focal length f2 of the second lens satisfy: 0.4<(EP01+EP12)/(f1+f2)<0.8.

By reasonably setting the ratio of the sum of the inner diameters of the object-side surfaces of the fourth spacing piece and the fifth spacing piece to the combined focal length of the fourth lens, the fifth lens and the sixth lens, the optical imaging lens assembly provided in embodiments of the present disclosure is capable of making the fourth spacing piece and the fifth spacing piece effectively block excess light without affecting the trend of the chief ray in the second lens group, thereby reducing the surface-type sensitivity of the lenses in the entire field of view; at the same time, combined with limiting the ratio of the air spacings between the spacing pieces in the second lens group and the corresponding lenses, the air spacing between the fourth lens and the fifth lens and the air spacing between the fifth lens and the sixth lens can be reasonably restricted, so as to avoid the gap between the two air spacings being too large, and effectively reduce the sensitivity of the two air spacings. The performance loss caused by optical imaging lens deformation can be reduced and the yield of optical imaging lens can be improved.

### BRIEF DESCRIPTION OF THE DRAWINGS

Other features, objectives and advantages of the present disclosure will become more apparent through the detailed descriptions of non-limiting embodiments given with reference to the following accompanying drawings.

FIG. 1 is a marking diagram of parameters of an optical imaging lens assembly according to the present disclosure;

FIG. 2 is a schematic structural diagram of an optical imaging lens assembly according to Embodiment 1 of the present disclosure;

FIG. 3 is a schematic structural diagram of an optical imaging lens assembly according to Embodiment 2 of the present disclosure;

FIG. 4 is a schematic structural diagram of an optical imaging lens assembly according to Embodiment 3 of the present disclosure;

FIGS. 5A-5C respectively illustrate a longitudinal aberration curve, an astigmatic curve and a distortion curve of the optical imaging lens assemblies according to Embodiments 1, 2 and 3 of the present disclosure;

FIG. 6 is a schematic structural diagram of an optical imaging lens assembly according to Embodiment 4 of the present disclosure;

FIG. 7 is a schematic structural diagram of an optical imaging lens assembly according to Embodiment 5 of the present disclosure;

FIG. 8 is a schematic structural diagram of an optical imaging lens assembly according to Embodiment 6 of the present disclosure;

FIGS. 9A-9C respectively illustrate a longitudinal aberration curve, an astigmatic curve and a distortion curve of the optical imaging lens assemblies according to Embodiments 4, 5 and 6 of the present disclosure;

FIG. 10 is a schematic structural diagram of an optical imaging lens assembly according to Embodiment 7 of the present disclosure;

FIG. 11 is a schematic structural diagram of an optical imaging lens assembly according to Embodiment 8 of the present disclosure;

FIG. 12 is a schematic structural diagram of an optical imaging lens assembly according to Embodiment 9 of the present disclosure;

FIGS. 13A-13C respectively illustrate a longitudinal aberration curve, an astigmatic curve and a distortion curve of the optical imaging lens assemblies according to Embodiments 7, 8 and 9 of the present disclosure;

FIG. 14A illustrates a modulation transfer function (MTF) curve when an optical imaging lens assembly satisfies CP4/T45−CP5/T56=2; and

FIG. 14B illustrates a modulation transfer function curve when an optical imaging lens assembly satisfies CP4/T45−CP5/T56=0.43.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements.

It should be noted that, in the specification, the expressions such as “first,” “second” and “third” are only used to distinguish one feature from another, rather than represent any limitations to the features. Thus, without departing from the teachings of the present disclosure, the first lens discussed below may also be referred to as the second lens or the third lens.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. A surface of each lens that is closest to a photographed object is referred to as the object-side surface of the lens, and a surface of each lens that is closest to an image plane is referred to as the image-side surface of the lens.

It should be further understood that the terms “comprise” and/or “have,” when used in the specification, specify the presence of stated features, elements and/or components, but do not exclude the presence or addition of one or more other features, elements, components and/or combinations thereof. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The present disclosure will be described below in detail with reference to the accompanying drawings and in combination with the embodiments.

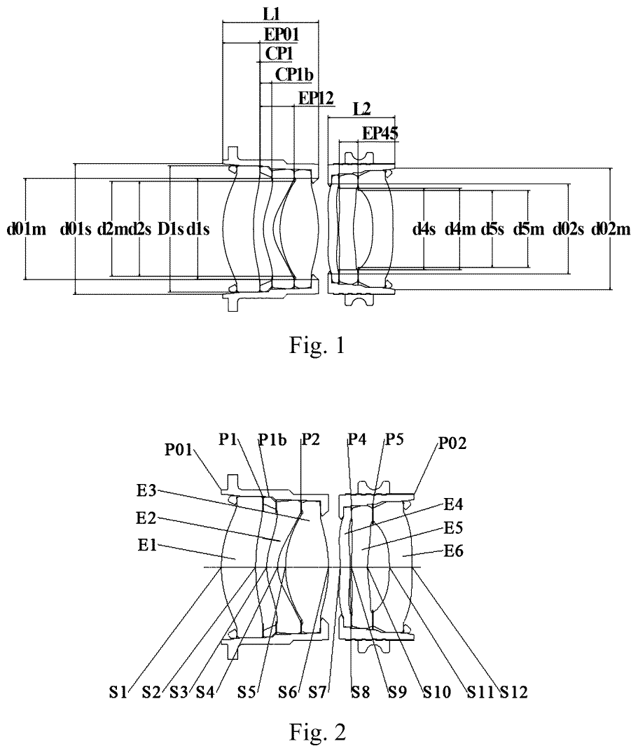

FIG. 1 is a marking diagram of parameters of an optical imaging lens assembly according to an exemplary implementation of the present disclosure. Referring to FIG. 1, d1s represents an inner diameter of an object-side surface of a first spacing piece, D1s represents an outer diameter of the object-side surface of the first spacing piece, d2s represents an inner diameter of an object-side surface of a second spacing piece, d2m represents an inner diameter of an image-side surface of the second spacing piece, d4s represents an inner diameter of an object-side surface of a fourth spacing piece, d4m represents an inner diameter of an image-side surface of the fourth spacing piece, d5s represents an inner diameter of an object-side surface of a fifth spacing piece, d5m represents an inner diameter of an image-side surface of the fifth spacing piece, d01s represents an inner diameter of an object-side end surface of a first lens barrel, d01m represents an inner diameter of an image-side end surface of the first lens barrel, d02s represents an inner diameter of an object-side end surface of a second lens barrel, d02m represents an inner diameter of an image-side end surface of the second lens barrel, EP01 represents a spacing between the object-side end surface of the first lens barrel and the first spacing piece along an optical axis, CP1 represents a maximal thickness of the first spacing piece, CP1b represents a maximal thickness of a first auxiliary spacing piece, EP12 represents a spacing between the first spacing piece and the second spacing piece along the optical axis, CP4 represents a maximal thickness of the fourth spacing piece, EP45 represents a spacing between the fourth spacing piece and the fifth spacing piece along the optical axis, CP5 represents a maximal thickness of the fifth spacing piece, L1 represents a length of the first lens barrel along a direction of the optical axis, and L2 represents a length of the second lens barrel along the direction of the optical axis.

Referring to FIGS. 2-4, 6-8 and 10-12, an optical imaging lens assembly is provided in a first aspect of the present disclosure, and the optical imaging lens assembly may include an optical lens group. The optical lens group may include a first lens group and a second lens group that are sequentially arranged along an optical axis from an object side to an image side. There may be an air spacing between the first lens group and the second lens group.

In an exemplary implementation, the first lens group may sequentially include a first lens, a second lens and a third lens along the optical axis from the object side to the image side.

In an exemplary implementation, the first lens group may have a positive refractive power. The first lens may have a positive refractive power. The second lens may have a negative refractive power. The third lens may have a positive refractive power.

In an exemplary implementation, the second lens group may have a negative refractive power, and may sequentially include, along the optical axis from the object side to the image side, a fourth lens having a positive refractive power, a fifth lens having a negative refractive power, and a sixth lens having a negative refractive power.

In an exemplary implementation, an object-side surface of the first lens may be a convex surface, and an image-side surface of the first lens may be a concave surface.

In an exemplary implementation, an object-side surface of the second lens may be a convex surface, and an image-side surface of the second lens may be a concave surface.

In an exemplary implementation, an object-side surface of the third lens may be a convex surface, and an image-side surface of the third lens may be a convex surface.

In an exemplary implementation, an object-side surface of the fourth lens may be a concave surface, and an image-side surface of the fourth lens may be a convex surface.

In an exemplary implementation, an object-side surface of the fifth lens may be a convex surface, and an image-side surface of the fifth lens may be a concave surface.

In an exemplary implementation, an object-side surface of the sixth lens may be a concave surface, and an image-side surface of the sixth lens may be a convex surface or a concave surface.

In an exemplary implementation, a number of lenses having refractive powers in the optical imaging lens assembly is six.

In an exemplary implementation, the position of the first lens group is fixed relative to the image plane on the optical axis. The second lens group may move relative to the first lens group along the optical axis, i.e., the distance from the second lens group to the first lens group on the optical axis is adjustable. When the distance of a photographed object from the optical imaging lens assembly is decreasing, the optical imaging lens assembly can switch between a telephoto state and a macro state by adjusting the distance between the second lens group and the first lens group on the optical axis, thereby realizing the focusing of the optical imaging lens assembly.

The focusing of the optical imaging lens assembly is realized by adjusting the gap between the first lens group and the second lens group, which can effectively avoid the pollution problem caused by the entry of external substances (e.g., dust) to the interior of the lens assembly, and avoid the problems of poor imaging effect, module friction and large loss caused by the zooming in a digital zoom mode, thereby improving the imaging effect and service life of the optical imaging lens assembly.

In an exemplary implementation, the positions of the first lens group and the second lens group are fixed relative to the image plane on the optical axis. That is, the distance between the first lens group and the second lens group on the optical axis is a fixed value.

In an exemplary implementation, the optical imaging lens assembly may further include a lens barrel assembly, and the lens barrel assembly may include a first lens barrel and a second lens barrel that are sequentially arranged along the optical axis from the object side to the image side. The first lens group may be placed in the first lens barrel. The second lens group may be placed in the second lens barrel.

In an exemplary implementation, the optical imaging lens assembly may further include a spacing piece group, and the spacing piece group includes one or more of a first spacing piece, a first auxiliary spacing piece, a second spacing piece, a fourth spacing piece and a fifth spacing piece. The first spacing piece and/or the second spacing piece are placed in the first lens barrel. The first auxiliary spacing piece is placed in the first lens barrel. The fourth spacing piece and/or the fifth spacing piece are placed in the second lens barrel. The first spacing piece may be placed on the image-side surface of the first lens and at least in partial contact with the image-side surface of the first lens. The first auxiliary spacing piece may be placed on an image-side surface of the first spacing piece and at least in partial contact with the image-side surface of the first spacing piece. The second spacing piece may be placed on the image-side surface of the second lens and at least in partial contact with the image-side surface of the second lens. The fourth spacing piece may be placed on the image-side surface of the fourth lens and at least in partial contact with the image-side surface of the fourth lens. The fifth spacing piece may be placed on the image-side surface of the fifth lens and at least in partial contact with the image-side surface of the fifth lens. The reasonable use of the spacing pieces can effectively avoid the risk of stray light, and reduce the interference with the image quality, thereby improving the imaging quality of the optical imaging lens assembly. Meanwhile, the stability of supporting of the lenses can also be ensured.

In an exemplary implementation, a combined focal length f456 of the fourth lens, the fifth lens and the sixth lens, an inner diameter d4s of an object-side surface of the fourth spacing piece, and an inner diameter d5s of an object-side surface of the fifth spacing piece may satisfy: −1.1<(d4s+d5s)/f456<0. By reasonably setting the ratio of the sum of the inner diameters of the object-side surfaces of the fourth spacing piece and the fifth spacing piece to the combined focal length of the fourth lens, the fifth lens and the sixth lens, it is possible to make the fourth spacing piece and the fifth spacing piece effectively block excess light without affecting the trend of the chief ray in the second lens group, thereby reducing the surface-type sensitivity of the lenses in the entire field of view.

In an exemplary implementation, an air spacing T45 between the fourth lens and the fifth lens on the optical axis, an air spacing T56 between the fifth lens and the sixth lens on the optical axis, a maximal thickness CP4 of the fourth spacing piece, and a maximal thickness CP5 of the fifth spacing piece may satisfy: 0.2<CP4/T45−CP5/T56<0.8. When the optical imaging lens assembly satisfies “−1.1<(d4s+d5s)/f456<0,” by reasonably setting the ratio of the maximal thickness of the fourth spacing piece to the air spacing between the fourth lens and the fifth lens also and the ratio of the maximal thickness of the fifth spacing piece to the air spacing between the fifth lens and the sixth lens, the two air spacings can be constrained within an appropriate range, to prevent the difference between the two air spacings from being too large, which effectively reduces the sensitivity of the two air spacings, thereby reducing the performance loss caused by the deformation of the optical imaging lens assembly. Accordingly, the yield of the optical imaging lens assembly is improved.

The relationship between the deformation of the air spacing between the lenses and the sensitivity is further illustrated below in combination with Tables 1 and 2. In Tables 1 and 2, “F” in “0.1F,” “0.2F,” “0.3F,” “0.4F,” “0.5F,” “0.6F,” “0.7F,” “0.8F,” “0.9F” and “1.0F” represents a field of view.

Table 1 shows the sensitivities of T45 and T56 to the field curvature in an S direction and the field curvature in a T direction when the optical imaging lens assembly satisfies “0.2<CP4/T45−CP5/T56<0.8,” for example, when the optical imaging lens assembly satisfies CP4/T45−CP5/T56=0.43. For example, in the field of view of 0.7, when T45 is slightly deformed, the offset of the field curvature in the S direction is 0.29 μm, and the offset of the field curvature in the T direction is 0.98 μm. When T56 is slightly deformed, the offset of the field curvature in the S direction is 0.21 μm, and the offset of the field curvature in the T direction is 0.56 μm.

Table 2 shows the sensitivities of T45 and T56 to the field curvature in the S direction and the field curvature in the T direction when the optical imaging lens assembly does not satisfy “0.2<CP4/T45−CP5/T56<0.8,” for example, when the optical imaging lens assembly satisfies CP4/T45−CP5/T56=2. For example, in the field of view of 0.7, when T45 is slightly deformed, the offset of the field curvature in the S direction is −1.02 μm, and the offset of the field curvature in the T direction is −1.66 μm. When T56 is slightly deformed, the offset of the field curvature in the S direction is −1.25 μm, and the offset of the field curvature in the T direction is −1.74 μm.

It can be seen from the data provided in Tables 1 and 2 that, when the optical imaging lens assembly satisfies “0.2<CP4/T45−CP5/T56<0.8,” the sensitivities of the deformations of T45 and T56 to the field curvature in the S direction and the field curvature in the T direction are significantly reduced, thereby effectively improving the MTF yield of the optical imaging lens assembly.

TABLE 1

| Field | Direction | | | | | |
|---|---|---|---|---|---|---|
| of | of field | | | | | |
| view | curvature | CT4 | T45 | CT5 | T56 | CT6 |
| 0 | / | −0.08 | 0 | 0 | −0.04 | 0 |
| 0.1F | S | 0 | 0 | 0.01 | −0.01 | 0 |
| | T | 0.12 | −0.02 | −0.05 | 0.02 | 0 |
| 0.2F | S | 0.16 | −0.03 | −0.07 | 0.05 | −0.02 |
| | T | 0.51 | −0.03 | −0.23 | 0.19 | −0.01 |
| 0.3F | S | 0.29 | −0.03 | −0.17 | 0.08 | −0.01 |
| | T | 0.86 | −0.05 | −0.62 | 0.22 | −0.05 |
| 0.4F | S | 0.48 | 0.01 | −0.38 | 0.08 | 0 |
| | T | 1.26 | 0.13 | −1.16 | 0.22 | −0.07 |
| 0.5F | S | 0.68 | 0.1 | −0.62 | 0.11 | −0.03 |
| | T | 1.69 | 0.36 | −1.65 | 0.21 | −0.08 |
| 0.6F | S | 0.95 | 0.2 | −0.91 | 0.1 | −0.03 |
| | T | 2.17 | 0.64 | −2.05 | 0.38 | −0.05 |
| 0.7F | S | 1.22 | 0.29 | −1.1 | 0.21 | −0.03 |
| | T | 2.61 | 0.98 | −2.47 | 0.56 | −0.04 |
| 0.8F | S | 1.58 | 0.4 | −1.22 | 0.36 | −0.04 |
| | T | 3.37 | 1.58 | −2.49 | 0.99 | 0.03 |
| 0.9F | S | 2.23 | 0.6 | −1.37 | 0.59 | −0.02 |
| | T | 4.39 | 2.31 | −1.62 | 1.45 | 0.18 |
| 1.0F | S | 2.66 | 0.64 | −1.17 | 0.83 | 0.02 |
| | T | −0.74 | 4.64 | 5.75 | −0.7 | 0.29 |

TABLE 2

| Field | Direction | | | | | |
|---|---|---|---|---|---|---|
| of | of field | | | | | |
| view | curvature | CT4 | T45 | CT5 | T56 | CT6 |
| 0 | / | −0.09 | 0.01 | 0 | −0.07 | 0 |
| 0.1F | S | −0.15 | −0.06 | 0.04 | −0.04 | 0.01 |
| | T | −0.24 | −0.11 | 0.08 | −0.1 | 0.02 |
| 0.2F | S | −0.28 | −0.09 | 0.06 | −0.12 | 0.04 |
| | T | −0.51 | −0.19 | 0.2 | −0.3 | 0.1 |
| 0.3F | S | −0.47 | −0.18 | 0.1 | −0.27 | 0.07 |
| | T | −0.98 | −0.34 | 0.35 | −0.59 | 0.19 |
| 0.4F | S | −0.88 | −0.29 | 0.18 | −0.47 | 0.13 |
| | T | −1.78 | −0.58 | 0.59 | −0.97 | 0.34 |
| 0.5F | S | −1.53 | −0.48 | 0.3 | −0.7 | 0.21 |
| | T | −2.86 | −0.85 | 0.94 | −1.32 | 0.57 |
| 0.6F | S | −2.97 | −0.73 | 0.54 | −1 | 0.36 |
| | T | −4.17 | −1.23 | 1.43 | −1.65 | 0.82 |
| 0.7F | S | −4.55 | −1.02 | 0.8 | −1.25 | 0.47 |
| | T | −6.19 | −1.66 | 2.05 | −1.74 | 1.16 |
| 0.8F | S | −5.87 | −1.29 | 1.14 | −1.3 | 0.64 |
| | T | −8.51 | −2.14 | 2.93 | −1.51 | 1.61 |
| 0.9F | S | −6.08 | −1.58 | 1.81 | −1.34 | 0.92 |
| | T | −10.61 | −2.51 | 4.06 | −0.71 | 2.26 |
| 1.0F | S | −7.21 | −1.77 | 2.02 | −1.18 | 1.09 |
| | T | −14.13 | −2.26 | 6.23 | 0.15 | 3.54 |

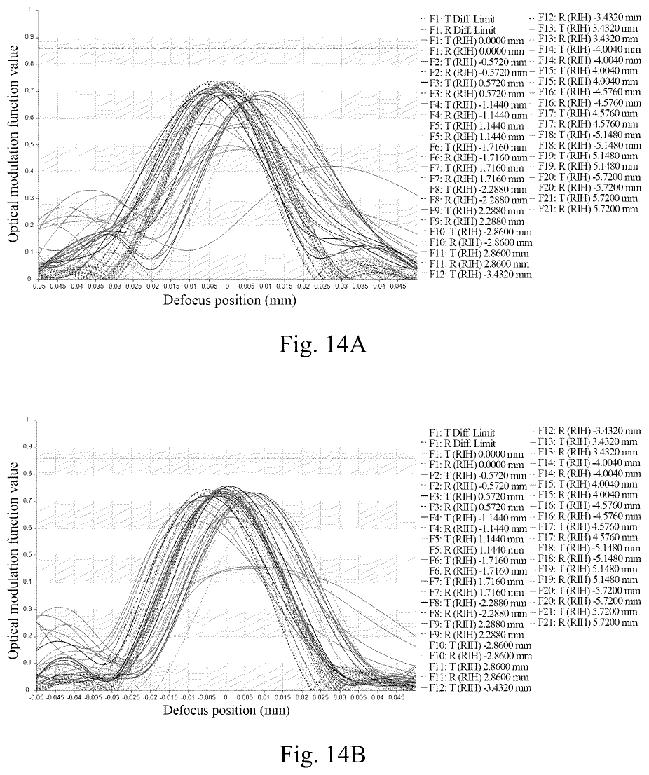

FIG. 14A illustrates a modulation transfer function curve when an optical imaging lens assembly satisfies CP4/T45−CP5/T56=2. FIG. 14B illustrates a modulation transfer function curve when an optical imaging lens assembly satisfies CP4/T45−CP5/T56=0.43. It can be seen from FIG. 14A that, when the optical imaging lens assembly satisfies CP4/T45−CP5/T56=2, the peak of the optical modulation function value of the optical imaging lens assembly is at a defocus position within the range from −0.015 mm to 0.025 mm. It can be seen from FIG. 14B that, when the optical imaging lens assembly satisfies CP4/T45−CP5/T56=0.43, the peak of the optical modulation function value of the optical imaging lens assembly is at a defocus position within the range from −0.01 mm to 0.01 mm. Accordingly, by controlling the optical imaging lens assembly to satisfy “0.2<CP4/T45−CP5/T56<0.8,” it helps to improve the performance of the optical imaging lens assembly.

In an exemplary implementation, an effective aperture DT41 of the object-side surface of the fourth lens, an effective aperture DT62 of the image-side surface of the sixth lens, an inner diameter d02s of an object-side end surface of the second lens barrel, and an inner diameter d02m of an image-side end surface of the second lens barrel may satisfy: −0.3<d02s/DT41−d02m/DT62<0. By controlling the above conditional expression, the effective apertures of the front and rear surfaces of the second lens group can be constrained, to adjust the inner diameters of the object-side end surface and image-side end surface of the second lens barrel, thereby effectively preventing excess light from entering the system and blocking the excess stray light caused by the spacing piece while not affecting the imaging of the optical imaging lens assembly. Accordingly, the imaging quality of the optical imaging lens assembly is improved.

In an exemplary implementation, a radius of curvature R6 of the image-side surface of the third lens, a radius of curvature R7 of the object-side surface of the fourth lens, an inner diameter d01m of an image-side end surface of the first lens barrel, and the inner diameter d02s of the object-side end surface of the second lens barrel satisfy: −0.3<d01m/R6−d02s/R7<0.3. By controlling the above conditional expression, the radii of curvature of the adjacent surfaces between the two lens groups and the inner diameters of the adjacent side-end surfaces of the two lens barrels can be constrained, thereby ensuring the angle of refraction and the traveling of the light between the two lens groups, thereby ensuring the amount of light passing through the optical imaging lens assembly.

In an exemplary implementation, a center thickness CT5 of the fifth lens on the optical axis, a refractive index N5 of the fifth lens, an inner diameter d4m of an image-side surface of the fourth spacing piece, and an inner diameter d5m of an image-side surface of the fifth spacing piece may satisfy: 0.2<(d4m−d5m)/CT5×N5<0.8. By controlling the above conditional expression, the center thickness and refractive index of the fifth lens and the image-side surfaces of the image-side surfaces of two adjacent spacing pieces can be constrained, to ensure the stability of the light before and after passing through the fifth lens, and block excess light, thereby improving the optical performance of the optical imaging lens assembly.

In an exemplary implementation, an axial distance SAG51 from an intersection point of the object-side surface of the fifth lens and the optical axis to a projection point of an effective semi-aperture vertex of the object-side surface of the fifth lens onto the optical axis, an axial distance SAG52 from an intersection point of the image-side surface of the fifth lens and the optical axis to a projection point of an effective semi-aperture vertex of the image-side surface of the fifth lens onto the optical axis, and a spacing EP45 between the fourth spacing piece and the fifth spacing piece along the optical axis may satisfy: 2<EP45/(SAG51+SAG52)<5. By controlling the above conditional expression, the ratio of the spacing between the fourth spacing piece and the fifth spacing piece along the optical axis to the sum of the sagittal heights of the object-side surface and image-side surface of the fifth lens can be constrained, to ensure that the fifth lens has an appropriate thickness-to-thin ratio, which is conducive to the processing and molding of the fifth lens and reducing the surface-type sensitivity of the fifth lens.

In an exemplary implementation, a combined focal length f123 of the first lens, the second lens and the third lens, the combined focal length f456 of the fourth lens, the fifth lens and the sixth lens, a length L1 of the first lens barrel along a direction of the optical axis, and a length L2 of the second lens barrel along the direction of the optical axis may satisfy: −2<f123/L1+f456/L2<−0.8. By controlling the above conditional expression, the ratio of the focal length of the first lens group to the length of the first lens barrel, and the ratio of the focal length of the second lens group to the length of the second lens barrel can be constrained, so as to reasonably distribute the refractive powers of lens groups according to the length of each lens barrel, thereby effectively reducing the sensitivity of the optical imaging lens assembly while making the optical imaging lens assembly have a good imaging quality. Accordingly, the optical performance and yield of assembling of the optical imaging lens assembly are improved.

In an exemplary implementation, an effective focal length f1 of the first lens, an abbe number V1 of the first lens, an inner diameter d01s of an object-side end surface of the first lens barrel, and an inner diameter d1s of an object-side surface of the first spacing piece may satisfy: 4<(d01s−d1s)/f1×V1<8. By controlling the above conditional expression, the effective focal length and abbe number of the first lens can be constrained, to adjust the inner diameters of the blocking elements before and behind the first lens (e.g., the inner diameter of the object-side end surface of the first lens barrel, and the inner diameter of the object-side surface of the first spacing piece), thereby preventing excess light from entering the system and blocking the stray light caused by reflection by the mechanism portion (non-effective aperture portion) of the first lens. Accordingly, the imaging quality of the optical imaging lens assembly is improved.

In an exemplary implementation, an effective aperture DT12 of the image-side surface of the first lens, the inner diameter d1s of the object-side surface of the first spacing piece, and an outer diameter D1s of the object-side surface of the first spacing piece may satisfy: 0<(D1s−d1s)/DT12<0.3. By controlling the above conditional expression, the size of the effective aperture portion of the first lens can be constrained, to adjust the inner and outer diameters of the spacing piece adjacent to the first lens, thereby reducing the outer diameter of the object-side surface of the first spacing piece while ensuring the processability of the first spacing piece and not affecting the imaging of the optical imaging lens assembly. Accordingly, the space occupied by the first spacing piece is reduced, the cost is saved, and the market competitiveness of the optical imaging lens assembly is improved.

In an exemplary implementation, an air spacing T12 between the first lens and the second lens on the optical axis, a maximal thickness CP1 of the first spacing piece, and a maximal thickness CP1b of the first auxiliary spacing piece may satisfy: 0.5<(CP1+CP1b)/T12<2.5. By controlling the above conditional expression, the air spacing between the first lens and the second lens can be constrained, to adjust the thicknesses of the first spacing piece and the first auxiliary spacing piece, which ensures the strength of assembling of the optical imaging lens assembly, thereby improving the stability of assembling of the optical imaging lens assembly.

In an exemplary implementation, an effective aperture DT22 of the image-side surface of the second lens, an effective aperture DT31 of the object-side surface of the third lens, an inner diameter d2s of an object-side surface of the second spacing piece, and an inner diameter d2m of an image-side surface of the second spacing piece may satisfy: −0.1<d2m/DT31−d2s/DT22<0.1. By controlling the above conditional expression, the effective aperture of the image-side surface of the second lens and the effective aperture of the object-side surface of the third lens can be constrained, to adjust the inner diameters of the object-side surface and the image-side surface of the second spacing piece can be adjusted, and accordingly, it is ensured that the second spacing piece can effectively block excess stray light without affecting the imaging of the optical imaging lens assembly, thereby improving the imaging quality of the optical imaging lens assembly.

In an exemplary implementation, an axial distance SAG21 from an intersection point of the object-side surface of the second lens and the optical axis to a projection point of an effective semi-aperture vertex of the object-side surface of the second lens onto the optical axis, an axial distance SAG22 from an intersection point of the image-side surface of the second lens and the optical axis to a projection point of an effective semi-aperture vertex of the image-side surface of the second lens onto the optical axis, and a spacing EP12 between the first spacing piece and the second spacing piece along the optical axis may satisfy: 1<EP12/(SAG21+SAG22)<2. By controlling the above conditional expression, the ratio of the spacing between the first spacing piece and the second spacing piece along the optical axis to the sum of the sagittal heights of the object-side surface and image-side surface of the second lens can be constrained, to ensure that the second lens has an appropriate thickness-to-thin ratio, which is conducive to the processing and molding of the second lens and reducing the surface-type sensitivity of the second lens.

In an exemplary implementation, a spacing EP01 between the object-side end surface of the first lens barrel and the first spacing piece along the optical axis, a spacing EP12 between the first spacing piece and the second spacing piece along the optical axis, the effective focal length f1 of the first lens, and an effective focal length f2 of the second lens may satisfy: 0.4<(EP01+EP12)/(f1+f2)<0.8. By controlling the above conditional expression, the effective focal lengths of the first lens and the second lens can be constrained within a reasonable range. Meanwhile, by additionally limiting the spacing between the object-side end surface of the first lens barrel and the first spacing piece along the optical axis and the spacing between the first spacing piece and the second spacing piece along the optical axis, it can be ensured that the first spacing and the second spacing piece are reasonably arranged in the first lens barrel, which is conducive to improving the stability of assembling of the optical imaging lens assembly and reducing the risk of deformation.

The optical imaging lens assembly according to the above implementations of the present disclosure may use six lenses, two lens barrels and at least one spacing piece. By reasonably distributing the parameters of each lens, each lens barrel and each spacing piece, it is possible to reduce the sensitivity of the optical imaging lens assembly and improve the risk of stray light of the optical imaging lens assembly, thereby improving the imaging quality, stability of assembling and yield of assembling of the optical imaging lens assembly.

In the implementations of the present disclosure, at least one of the surfaces of any lens in the first lens to the sixth lens is an aspheric surface. An aspheric lens is characterized in that the curvature continuously changes from the center of the lens to the periphery of the lens. Different from a spherical lens having a constant curvature from the center of the lens to the periphery of the lens, the aspheric lens has a better radius-of-curvature characteristic, and has advantages of improving the distortion aberration and improving the astigmatic aberration. The use of the aspheric lens can eliminate as much as possible the aberrations that occur during the imaging, thereby improving the imaging quality. Alternatively, the object-side surface and image-side surface of any lens in the first lens to the sixth lens are both aspheric surfaces.

An optical imaging lens assembly is provided in a second aspect of the present disclosure, and the optical imaging lens assembly includes a lens barrel assembly and an optical lens group. The optical lens group includes a first lens group and a second lens group that are sequentially arranged along an optical axis from an object side to an image side, and the second lens group has a negative refractive power. The first lens group includes a first lens, a second lens and a third lens, and the second lens group includes a fourth lens having a positive refractive power, a fifth lens having a negative refractive power, and a sixth lens having a negative refractive power. The lens barrel assembly includes a first lens barrel and a second lens barrel. The first lens group is placed in the first lens barrel, and the second lens group is placed in the second lens barrel. The number of lenses having refractive powers in the optical imaging lens assembly is six.

Here, a radius of curvature R6 of an image-side surface of the third lens, a radius of curvature R7 of an object-side surface of the fourth lens, an inner diameter d01m of an image-side end surface of the first lens barrel, and an inner diameter d02s of an object-side end surface of the second lens barrel may satisfy: −0.3<d01m/R6−d02s/R7<0.3. By controlling the above conditional expression, the radii of curvature of the adjacent surfaces in the two lens groups and the inner diameters of the adjacent side-end surfaces of the two lens barrels can be constrained, thereby ensuring the angle of refraction and the traveling of the light between the two lens groups, thereby ensuring the amount of light passing through the optical imaging lens assembly.

An optical imaging lens assembly is provided in a third aspect of the present disclosure, and the optical imaging lens assembly includes a lens barrel assembly and an optical lens group. The optical lens group includes a first lens group and a second lens group that are sequentially arranged along an optical axis from an object side to an image side, and the second lens group has a negative refractive power. The first lens group includes a first lens, a second lens and a third lens, and the second lens group includes a fourth lens having a positive refractive power, a fifth lens having a negative refractive power, and a sixth lens having a negative refractive power. The lens barrel assembly includes a first lens barrel and a second lens barrel. The first lens group is placed in the first lens barrel, and the second lens group is placed in the second lens barrel. The number of lenses having refractive powers in the optical imaging lens assembly is six.

Here, a combined focal length f123 of the first lens, the second lens and the third lens, a combined focal length f456 of the fourth lens, the fifth lens and the sixth lens, a length L1 of the first lens barrel along a direction of the optical axis and a length L2 of the second lens barrel along the direction of the optical axis may satisfy: −2<f123/L1+f456/L2<−0.8. By controlling the above conditional expression, the ratio of the focal length of the first lens group to the length of the first lens barrel, and the ratio of the focal length of the second lens group to the length of the second lens barrel can be constrained, so as to reasonably distribute the refractive power of each lens group according to the length of each lens barrel, thereby effectively reducing the sensitivity of the optical imaging lens assembly while making the optical imaging lens assembly have a good imaging quality. Accordingly, the optical performance and yield of assembling of the optical imaging lens assembly are improved.

It should be understood by those skilled in the art that the various results and advantages described in the present specification may be obtained by changing the numbers of the lenses and the spacing pieces that constitute the optical imaging lens assembly without departing from the technical solution claimed by the present disclosure.

Detailed embodiments of the optical imaging lens assembly that may be applicable to the above implementations are further described below with reference to the accompanying drawings.

### Embodiment 1

An optical imaging lens assembly according to Embodiment 1 of the present disclosure is described below with reference to FIG. 2.

As shown in FIG. 2, the optical imaging lens assembly includes a lens barrel assembly, an optical lens group and a spacing piece group. The lens barrel assembly includes a first lens barrel P01 and a second lens barrel P02.

The optical lens group sequentially includes, along an optical axis from an object side to an image side, a first lens group placed in the first lens barrel P01 and a second lens group placed in the second lens barrel P02, the second lens barrel P02 has a negative refractive power. The first lens group includes a first lens E1, a second lens E2 and a third lens E3. The second lens group includes a fourth lens E4, a fifth lens E5 and a sixth lens E6.

The first lens E1 has a positive refractive power, an object-side surface S1 of the first lens E1 is a convex surface, and an image-side surface S2 of the first lens E1 is a concave surface. The second lens E2 has a negative refractive power, an object-side surface S3 of the second lens E2 is a convex surface, and an image-side surface S4 of the second lens E2 is a concave surface. The third lens E3 has a positive refractive power, an object-side surface S5 of the third lens E3 is a convex surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a convex surface, and an image-side surface S10 of the fifth lens E5 is a concave surface. The sixth lens E6 has a negative refractive power, an object-side surface S11 of the sixth lens E6 is a concave surface, and an image-side surface S12 of the sixth lens E6 is a convex surface. An optical filter is further disposed between the sixth lens E6 and an image plane S15, and the optical filter has an object-side surface S13 (not shown) and an image-side surface S14 (not shown). Light from an object sequentially passes through the surfaces S1-S14, and finally forms an image on the image plane S15 (not shown).

The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b, and the second spacing piece P2 are placed in the first lens barrel P01. The fourth spacing piece P4 and the fifth spacing piece P5 are placed in the second lens barrel P02. The spacing pieces can block the entry of excess light to a next lens during imaging, and at the same time, can make the lenses better supported against the first lens barrel P01 and the second lens barrel P02, enhancing the structural stability of the optical imaging lens assembly.

Table 3 is a table showing basic parameters of the optical imaging lens assembly of Embodiment 1. Here, the units of a radius of curvature, a thickness/distance, a focal length and an effective semi-aperture are millimeters (mm).

TABLE 3

| | | | | material | | | effective |
|---|---|---|---|---|---|---|---|
| surface | surface | radius of | | refractive | abbe | focal | semi- |
| number | type | curvature | thickness | index | number | length | aperture |
| OBJ | | infinite | infinite | | | | |
| S1 | aspheric | 8.2299 | 2.8417 | 1.49 | 70.4 | 26.17 | 4.8444 |
| S2 | aspheric | 20.4679 | 1.6069 | | | | 4.6743 |
| S3 | aspheric | 4.6830 | 0.7691 | 1.62 | 25.9 | −14.39 | 4.3001 |
| S4 | aspheric | 2.8773 | 0.6915 | | | | 4.1254 |
| S5 | aspheric | 6.4384 | 3.7000 | 1.54 | 56.11 | 8.02 | 4.1930 |
| S6 | aspheric | −10.9203 | 0.9633 | | | | 4.0090 |
| S7 | aspheric | −7.9855 | 0.7499 | 1.66 | 20.37 | 239.61 | 3.5741 |
| S8 | aspheric | −7.8908 | 0.0498 | | | | 3.5186 |
| S9 | aspheric | 6.9625 | 0.8526 | 1.54 | 56.11 | −38.26 | 3.4841 |
| S10 | aspheric | 4.9960 | 1.9651 | | | | 3.3313 |
| S11 | aspheric | −7.5647 | 1.5878 | 1.54 | 56.11 | −20.47 | 3.3800 |
| S12 | aspheric | −25.1565 | 4.2474 | | | | 4.3206 |
| S13 | | infinite | 0.2100 | 1.52 | 64.2 | | 8.0000 |
| S14 | | infinite | 1.0152 | | | | 8.0000 |
| S15 | | infinite | 0.0000 | | | | 5.8804 |

In this embodiment, the value of a total effective focal length f of the optical imaging lens assembly is 18.61 mm. The value of half of a maximal field-of-view Semi-FOV of the optical imaging lens assembly is 17.24°. The value of a combined focal length f123 of the first lens, the second lens and the third lens is 12.19 mm. The value of a combined focal length f456 of the fourth lens, the fifth lens and the sixth lens is −13.75 mm.

In this embodiment, the object-side surface and the image-side surface of any lens in the first to sixth lenses E1-E6 are both aspheric surfaces, and the surface type x of each aspheric lens may be defined using, but not limited to, the following formula:

$$x = \frac{c {h}^{2}}{1 + \sqrt{1 - ( k + 1 ) {c}^{2} {h}^{2}}} + \sum Ai {h}^{i} ( 1 ) \qquad ( 1 )$$

Here, X is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 3 above); k is the conic coefficient; and Ai is the correction coefficient of an i-th order of the aspheric surface. Table 4 shows the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 1.

TABLE 4

| surface | | | | | | | |
|---|---|---|---|---|---|---|---|
| number | A4 | A6 | A8 | A10 | A12 | A14 | A16 |
| S1 | 1.3104E−04 | −7.3965E−05 | 1.4102E−05 | −1.9312E−06 | 1.6852E−07 | −9.5470E−09 | 3.3653E−10 |
| S2 | 8.2430E−04 | −2.9512E−04 | 6.2876E−05 | −8.7419E−06 | 7.6592E−07 | −4.3167E−08 | 1.5189E−09 |
| S3 | −4.3191E−03 | −2.0257E−03 | 5.6623E−04 | −6.5325E−05 | −2.2696E−06 | 2.0674E−06 | −3.7006E−07 |
| S4 | −2.1628E−03 | −3.8062E−03 | 1.2592E−03 | −2.2499E−04 | 2.4914E−05 | −1.7477E−06 | 7.5623E−08 |
| S5 | 1.4914E−03 | −7.9252E−04 | 3.6413E−05 | 4.3693E−05 | −1.4067E−05 | 2.2081E−06 | −2.1290E−07 |
| S6 | 1.4590E−03 | −1.1088E−03 | 5.5341E−04 | −1.8032E−04 | 4.0727E−05 | −6.4890E−06 | 7.3137E−07 |
| S7 | 1.5329E−02 | −5.5218E−03 | 2.1829E−03 | −6.1800E−04 | 1.2106E−04 | −1.6467E−05 | 1.5539E−06 |
| S8 | 5.7299E−03 | −2.3502E−03 | 2.2094E−03 | −1.1046E−03 | 3.5890E−04 | −8.4081E−05 | 1.4864E−05 |
| S9 | −2.3824E−02 | 3.3607E−03 | 1.3982E−03 | −1.1566E−03 | 4.0126E−04 | −8.4788E−05 | 1.1562E−05 |
| S10 | −1.9037E−02 | 2.5103E−03 | 2.7974E−04 | −3.7375E−04 | 1.4355E−04 | −3.3465E−05 | 5.2536E−06 |
| S11 | −3.8520E−03 | 2.1161E−03 | −2.0755E−03 | 1.2719E−03 | −5.2826E−04 | 1.5369E−04 | −3.1865E−05 |
| S12 | −1.1451E−03 | −4.4117E−04 | 2.6253E−04 | −9.8765E−05 | 2.5141E−05 | −4.4905E−06 | 5.7608E−07 |
| surface | | | | | | | |
| number | A18 | A20 | A22 | A24 | A26 | A28 | A30 |
| S1 | −6.7134E−12 | 5.7898E−14 | 0.0000E+00 | 0.0000E+00 | 0.0000E+00 | 0.0000E+00 | 0.0000E+00 |
| S2 | −3.0352E−11 | 2.6320E−13 | 0.0000E+00 | 0.0000E+00 | 0.0000E+00 | 0.0000E+00 | 0.0000E+00 |
| S3 | 3.8800E−08 | −2.6730E−09 | 1.2154E−10 | −3.4355E−12 | 5.0159E−14 | −1.0526E−16 | −4.3850E−18 |
| S4 | −1.8421E−09 | 1.9331E−11 | 0.0000E+00 | 0.0000E+00 | 0.0000E+00 | 0.0000E+00 | 0.0000E+00 |
| S5 | 1.3449E−08 | −5.6404E−10 | 1.5325E−11 | −2.4796E−13 | 1.8433E−15 | 0.0000E+00 | 0.0000E+00 |
| S6 | −5.7688E−08 | 3.0982E−09 | −1.0709E−10 | 2.1052E−12 | −1.6033E−14 | −5.7145E−17 | 0.0000E+00 |
| S7 | −1.0001E−07 | 4.1912E−09 | −1.0286E−10 | 1.1146E−12 | 0.0000E+00 | 0.0000E+00 | 0.0000E+00 |
| S8 | −2.0038E−06 | 2.0357E−07 | −1.5187E−08 | 7.9925E−10 | −2.7818E−11 | 5.6818E−13 | −5.0782E−15 |
| S9 | −9.6639E−07 | 3.4160E−08 | 2.1362E−09 | −3.4946E−10 | 2.0288E−11 | −5.8832E−13 | 7.0609E−15 |
| S10 | −5.6879E−07 | 4.1945E−08 | −2.0057E−09 | 5.5658E−11 | −6.7172E−13 | 0.0000E+00 | 0.0000E+00 |
| S11 | 4.7277E−06 | −4.9761E−07 | 3.6236E−08 | −1.7334E−09 | 4.8931E−11 | −6.1647E−13 | 0.0000E+00 |
| S12 | −5.3803E−08 | 3.6691E−09 | −1.8099E−10 | 6.2895E−12 | −1.4592E−13 | 2.0237E−15 | −1.2633E−17 |

### Embodiment 2

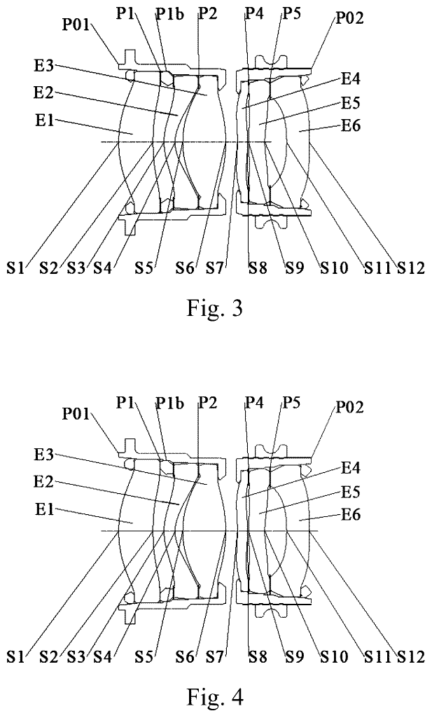

An optical imaging lens assembly according to Embodiment 2 of the present disclosure is described below with reference to FIG. 3.

As shown in FIG. 3, the optical imaging lens assembly includes a lens barrel assembly, an optical lens group and a spacing piece group. The lens barrel assembly includes a first lens barrel P01 and a second lens barrel P02. The structure of the optical lens group is the same as that of the optical lens group in Embodiment 1. The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b and the second spacing piece P2 are placed in the first lens barrel P01. The fourth spacing piece P4 and the fifth spacing piece P5 are placed in the second lens barrel P02.

The structure of the optical lens group in this embodiment is the same as that of the optical lens group in Embodiment 1, that is, the table of the basic parameters of the optical imaging lens assembly in this embodiment is the same as Table 3, and the table of the coefficients of the aspheric surfaces is the same as Table 4. This embodiment differs from Embodiment 1 in that: the structure sizes of at least some of the first lens barrel P01, the second lens barrel P02, the first spacing piece P1, the first auxiliary spacing piece P1b, the second spacing piece P2, the fourth spacing piece P4 and the fifth spacing piece P5 are different from that of Embodiment 1.

### Embodiment 3

An optical imaging lens assembly according to Embodiment 3 of the present disclosure is described below with reference to FIG. 4.

As shown in FIG. 4, the optical imaging lens assembly includes a lens barrel assembly, an optical lens group and a spacing piece group. The lens barrel assembly includes a first lens barrel P01 and a second lens barrel P02. The structure of the optical lens group is the same as that of the optical lens group in Embodiment 1. The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b, and the second spacing piece P2 are placed in the first lens barrel P01. The fourth spacing piece P4 and the fifth spacing piece P5 are placed in the second lens barrel P02.

The structure of the optical lens group in this embodiment is the same as that of the optical lens group in Embodiment 1, that is, the table of the basic parameters of the optical imaging lens assembly in this embodiment is the same as Table 3, and the table of the coefficients of the aspheric surfaces is the same as Table 4. This embodiment differs from Embodiment 1 in that: the structure sizes of at least some of the first lens barrel P01, the second lens barrel P02, the first spacing piece P1, the first auxiliary spacing piece P1b, the second spacing piece P2, the fourth spacing piece P4 and the fifth spacing piece P5 are different from that of Embodiment 1.

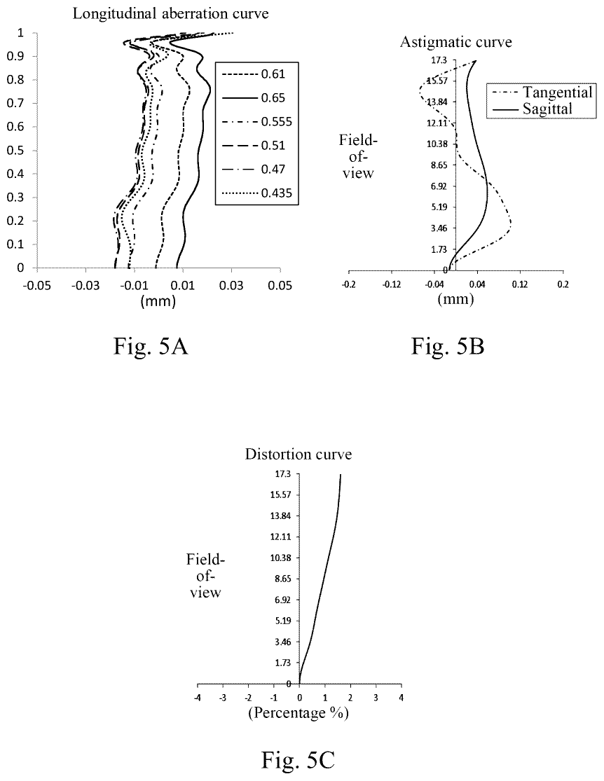

FIG. 5A illustrates a longitudinal aberration curve of the optical imaging lens assemblies of Embodiments 1, 2 and 3, representing deviations of focal points of light of different wavelengths converged after passing through an optical imaging lens assembly. FIG. 5B illustrates an astigmatic curve of the optical imaging lens assemblies of Embodiments 1, 2 and 3, representing curvatures of the tangential image plane and the curvature of a sagittal image plane that correspond to different field-of-views. FIG. 5C illustrates a distortion curve of the optical imaging lens assemblies of Embodiments 1, 2 and 3, representing amounts of distortion corresponding to different fields-of-views. It can be seen from FIGS. 5A-5C that the optical imaging lens assemblies given in Embodiments 1, 2 and 3 can achieve a good imaging quality.

### Embodiment 4

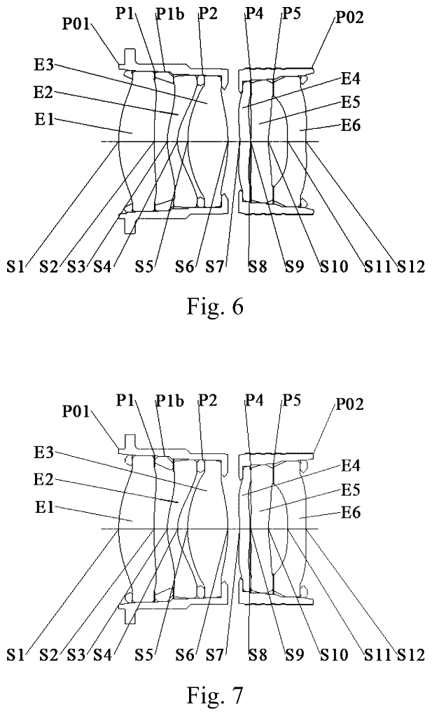

An optical imaging lens assembly according to Embodiment 4 of the present disclosure is described below with reference to FIG. 6.

As shown in FIG. 6, the optical imaging lens assembly includes a lens barrel assembly, an optical lens group and a spacing piece group. The lens barrel assembly includes a first lens barrel P01 and a second lens barrel P02.

The optical lens group sequentially includes, along an optical axis from an object side to an image side, a first lens group placed in the first lens barrel P01 and a second lens group placed in the second lens barrel P02, the second lens group has a negative refractive power. The first lens group includes a first lens E1, a second lens E2 and a third lens E3. The second lens group includes a fourth lens E4, a fifth lens E5 and a sixth lens E6.

The first lens E1 has a positive refractive power, an object-side surface S1 of the first lens E1 is a convex surface, and an image-side surface S2 of the first lens E1 is a concave surface. The second lens E2 has a negative refractive power, an object-side surface S3 of the second lens E2 is a convex surface, and an image-side surface S4 of the second lens E2 is a concave surface. The third lens E3 has a positive refractive power, an object-side surface S5 of the third lens E3 is a convex surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a convex surface, and an image-side surface S10 of the fifth lens E5 is a concave surface. The sixth lens E6 has a negative refractive power, an object-side surface S11 of the sixth lens E6 is a concave surface, and an image-side surface S12 of the sixth lens E6 is a concave surface. An optical filter is further disposed between the sixth lens E6 and an image plane S15, and the optical filter has an object-side surface S13 (not shown) and an image-side surface S14 (not shown). Light from an object sequentially passes through the surfaces S1-S14, and finally forms an image on the image plane S15 (not shown).

The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b, and the second spacing piece P2 are placed in the first lens barrel P01. The fourth spacing piece P4 and the fifth spacing piece P5 are placed in the second lens barrel P02. The spacing pieces can block the entry of excess light to a next lens during imaging, and at the same time, can make the lenses better supported against the first lens barrel P01 and the second lens barrel P02, enhancing the structural stability of the optical imaging lens assembly.

Table 5 is a table showing basic parameters of the optical imaging lens assembly of Embodiment 4. Here, the units of a radius of curvature, a thickness/distance, a focal length and an effective semi-aperture are millimeters (mm).

TABLE 5

| | | | | material | | | effective |
|---|---|---|---|---|---|---|---|
| surface | surface | radius of | | refractive | abbe | focal | semi- |
| number | type | curvature | thickness | index | number | length | aperture |
| OBJ | | infinite | infinite | | | | |
| S1 | aspheric | 8.7654 | 2.8000 | 1.49 | 70.4 | 22.15 | 4.7885 |
| S2 | aspheric | 41.2497 | 1.0408 | | | | 4.7426 |
| S3 | aspheric | 4.8432 | 0.8000 | 1.62 | 25.9 | −12.76 | 4.4002 |
| S4 | aspheric | 2.8130 | 0.8024 | | | | 4.2120 |
| S5 | aspheric | 6.7578 | 3.1815 | 1.54 | 56.11 | 8.14 | 4.2878 |
| S6 | aspheric | −10.8024 | 0.9320 | | | | 4.0402 |
| S7 | aspheric | −10.6501 | 0.8459 | 1.66 | 20.37 | 44.21 | 3.6832 |
| S8 | aspheric | −8.0712 | 0.0299 | | | | 3.6175 |
| S9 | aspheric | 17.1853 | 1.3942 | 1.54 | 56.11 | −17.85 | 3.6163 |
| S10 | aspheric | 6.0406 | 1.5198 | | | | 3.4789 |
| S11 | aspheric | −31.4531 | 1.4456 | 1.54 | 56.11 | −26.87 | 3.5178 |
| S12 | aspheric | 27.9245 | 4.7953 | | | | 4.4000 |
| S13 | | infinite | 0.2100 | 1.52 | 64.2 | | 8.0000 |
| S14 | | infinite | 1.2026 | | | | 8.0000 |
| S15 | | infinite | 0.0000 | | | | 5.8743 |

In this embodiment, the value of a total effective focal length f of the optical imaging lens assembly is 18.61 mm. The value of half of a maximal field-of-view Semi-FOV of the optical imaging lens assembly is 17.18°. The value of a combined focal length f123 of the first lens, the second lens and the third lens is 12.22 mm. The value of a combined focal length f456 of the fourth lens, the fifth lens and the sixth lens is −13.83 mm.

In this embodiment, the object-side surface and the image-side surface of any lens in the first to sixth lenses E1-E6 are both aspheric surfaces. Table 6 shows the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 4.

TABLE 6

| surface | | | | | | | |
|---|---|---|---|---|---|---|---|
| number | A4 | A6 | A8 | A10 | A12 | A14 | A16 |
| S1 | −3.6236E−05 | 5.6576E−05 | −5.5960E−05 | 2.3780E−05 | −6.2843E−06 | 1.0983E−06 | −1.3225E−07 |
| S2 | 9.4797E−04 | −2.2968E−04 | 1.0475E−04 | −3.3917E−05 | 6.8600E−06 | −9.6495E−07 | 1.0057E−07 |
| S3 | −8.3334E−03 | −7.0686E−04 | 8.1254E−04 | −3.2552E−04 | 8.1433E−05 | −1.4156E−05 | 1.7822E−06 |
| S4 | −1.0597E−02 | −8.9824E−04 | 1.3408E−03 | −5.8887E−04 | 1.5877E−04 | −2.9438E−05 | 3.9208E−06 |
| S5 | −7.8835E−04 | −4.2771E−04 | 2.4527E−04 | −6.3904E−05 | 6.8337E−06 | 5.9234E−07 | −3.2004E−07 |
| S6 | 5.0649E−04 | −1.8355E−04 | 6.9803E−05 | −5.3579E−06 | −4.6348E−06 | 2.0852E−06 | −4.6236E−07 |
| S7 | 1.0427E−02 | −2.0055E−03 | 4.9898E−04 | −5.7858E−05 | −1.9011E−05 | 1.2067E−05 | −3.3436E−06 |
| S8 | 1.0643E−02 | −2.4050E−03 | 4.0280E−04 | 2.6799E−04 | −2.2738E−04 | 8.6936E−05 | −2.1115E−05 |
| S9 | −8.5484E−03 | 7.4282E−04 | −6.5144E−04 | 7.3705E−04 | −3.9883E−04 | 1.3228E−04 | −2.9700E−05 |
| S10 | −1.5631E−02 | 3.0196E−03 | −1.1077E−03 | 5.3875E−04 | −2.3519E−04 | 8.1385E−05 | −2.1511E−05 |
| S11 | −7.8241E−03 | 2.0739E−03 | −2.4176E−03 | 1.8448E−03 | −9.3578E−04 | 3.3033E−04 | −8.3328E−05 |
| S12 | −3.2873E−03 | −1.3368E−04 | 1.3614E−04 | −4.9736E−05 | 1.2904E−05 | −2.4772E−06 | 3.5451E−07 |
| surface | | | | | | | |
| number | A18 | A20 | A22 | A24 | A26 | A28 | A30 |
| S1 | 1.1220E−08 | −6.7615E−10 | 2.8766E−11 | −8.4410E−13 | 1.6244E−14 | −1.8435E−16 | 9.3413E−19 |
| S2 | −8.0512E−09 | 4.9946E−10 | −2.3572E−11 | 8.1108E−13 | −1.8989E−14 | 2.6815E−16 | −1.7134E−18 |
| S3 | −1.6526E−07 | 1.1304E−08 | −5.6350E−10 | 1.9901E−11 | −4.7168E−13 | 6.7269E−15 | −4.3622E−17 |
| S4 | −3.8200E−07 | 2.7298E−08 | −1.4152E−09 | 5.1790E−11 | −1.2684E−12 | 1.8656E−14 | −1.2459E−16 |
| S5 | 5.4132E−08 | −5.4749E−09 | 3.6558E−10 | −1.6315E−11 | 4.6987E−13 | −7.9149E−15 | 5.9317E−17 |
| S6 | 6.5546E−08 | −6.3502E−09 | 4.2707E−10 | −1.9670E−11 | 5.9295E−13 | −1.0552E−14 | 8.4109E−17 |
| S7 | 5.8954E−07 | −7.1277E−08 | 5.9984E−09 | −3.4607E−10 | 1.3062E−11 | −2.9054E−13 | 2.8870E−15 |
| S8 | 3.5338E−06 | −4.1780E−07 | 3.4867E−08 | −2.0089E−09 | 7.5969E−11 | −1.6945E−12 | 1.6873E−14 |
| S9 | 4.7036E−06 | −5.3243E−07 | 4.2841E−08 | −2.3910E−09 | 8.7854E−11 | −1.9078E−12 | 1.8512E−14 |
| S10 | 4.2561E−06 | −6.1920E−07 | 6.4843E−08 | −4.7345E−09 | 2.2815E−10 | −6.5112E−12 | 8.3275E−14 |
| S11 | 1.5216E−05 | −2.0146E−06 | 1.9142E−07 | −1.2715E−08 | 5.6041E−10 | −1.4720E−11 | 1.7436E−13 |
| S12 | −3.7856E−08 | 2.9960E−09 | −1.7279E−10 | 7.0388E−12 | −1.9146E−13 | 3.1145E−15 | −2.2883E−17 |

### Embodiment 5

An optical imaging lens assembly according to Embodiment 5 of the present disclosure is described below with reference to FIG. 7.

As shown in FIG. 7, the optical imaging lens assembly includes a lens barrel assembly, an optical lens group and a spacing piece group. The lens barrel assembly includes a first lens barrel P01 and a second lens barrel P02. The structure of the optical lens group is the same as that of the optical lens group in Embodiment 4. The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b, and the second spacing piece P2 are placed in the first lens barrel P01. The fourth spacing piece P4 and the fifth spacing piece P5 are placed in the second lens barrel P02.

The structure of the optical lens group in this embodiment is the same as that of the optical lens group in Embodiment 4, that is, the table of the basic parameters of the optical imaging lens assembly in this embodiment is the same as Table 5, and the table of the coefficients of the aspheric surfaces is the same as Table 6. This embodiment differs from Embodiment 4 in that, the structure sizes of at least some of the first lens barrel P01, the second lens barrel P02, the first spacing piece P1, the first auxiliary spacing piece P1b, the second spacing piece P2, the fourth spacing piece P4 and the fifth spacing piece P5 are different from that of Embodiment 4.

### Embodiment 6

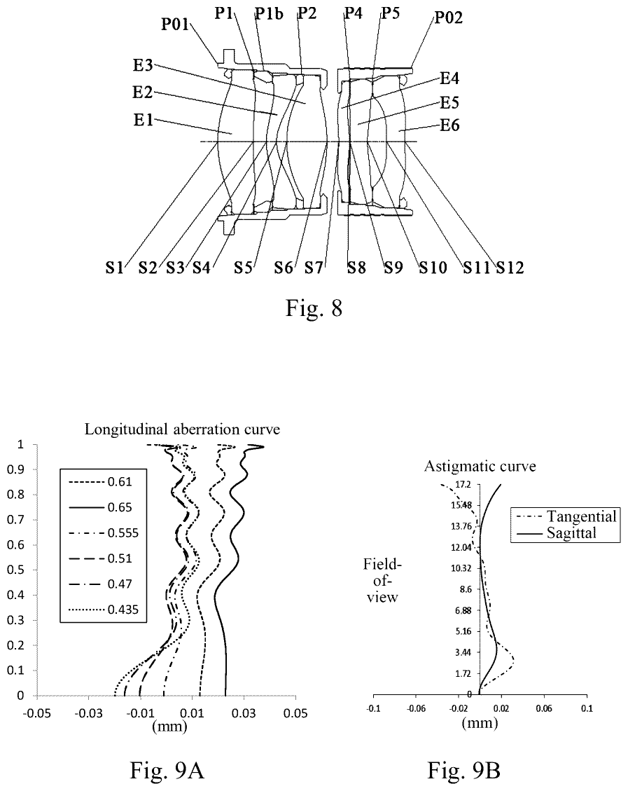

An optical imaging lens assembly according to Embodiment 6 of the present disclosure is described below with reference to FIG. 8.

As shown in FIG. 8, the optical imaging lens assembly includes a lens barrel assembly, an optical lens group and a spacing piece group. The lens barrel assembly includes a first lens barrel P01 and a second lens barrel P02. The structure of the optical lens group is the same as that of the optical lens group in Embodiment 4. The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b and the second spacing piece P2 are placed in the first lens barrel P01. The fourth spacing piece P4 and the fifth spacing piece P5 are placed in the second lens barrel P02.

The structure of the optical lens group in this embodiment is the same as that of the optical lens group in Embodiment 4, that is, the table of the basic parameters of the optical imaging lens assembly in this embodiment is the same as Table 5, and the table of the coefficients of the aspheric surfaces is the same as Table 6. This embodiment differs from Embodiment 4 in that, the structure sizes of at least some of the first lens barrel P01, the second lens barrel P02, the first spacing piece P1, the first auxiliary spacing piece P1b, the second spacing piece P2, the fourth spacing piece P4 and the fifth spacing piece P5 are different from that of Embodiment 1.

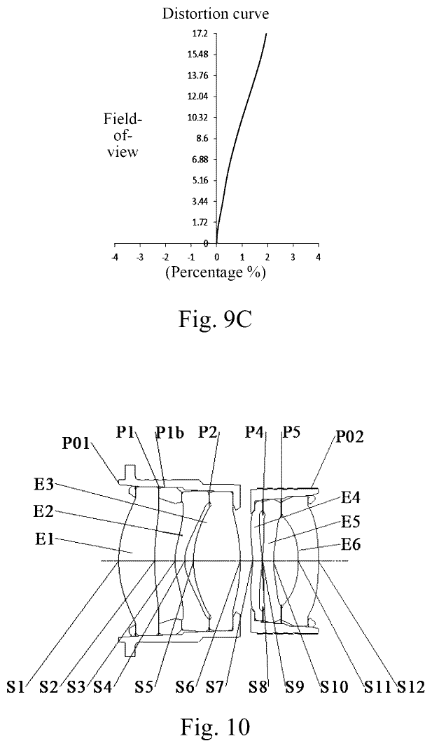

FIG. 9A illustrates a longitudinal aberration curve of the optical imaging lens assemblies of Embodiments 4, 5 and 6, representing deviations of focal points of light of different wavelengths converged after passing through an optical imaging lens assembly. FIG. 9B illustrates an astigmatic curve of the optical imaging lens assemblies of Embodiments 4, 5 and 6, representing curvatures of the tangential image plane and curvatures of a sagittal image plane that correspond to different field-of-views. FIG. 9C illustrates a distortion curve of the optical imaging lens assemblies of Embodiments 4, 5 and 6, representing amounts of distortion corresponding to different fields-of-views. It can be seen from FIGS. 9A-9C that the optical imaging lens assemblies given in Embodiments 4, 5 and 6 can achieve a good imaging quality.

### Embodiment 7

An optical imaging lens assembly according to Embodiment 7 of the present disclosure is described below with reference to FIG. 10.

As shown in FIG. 10, the optical imaging lens assembly includes a lens barrel assembly, an optical lens group and a spacing piece group. The lens barrel assembly includes a first lens barrel P01 and a second lens barrel P02.

The optical lens group sequentially includes, along an optical axis from an object side to an image side, a first lens group placed in the first lens barrel P01 and a second lens group placed in the second lens barrel P02, the second lens barrel P02 has a negative refractive power. The first lens group includes a first lens E1, a second lens E2 and a third lens E3. The second lens group includes a fourth lens E4, a fifth lens E5 and a sixth lens E6.

The first lens E1 has a positive refractive power, an object-side surface S1 of the first lens E1 is a convex surface, and an image-side surface S2 of the first lens E1 is a concave surface. The second lens E2 has a negative refractive power, an object-side surface S3 of the second lens E2 is a convex surface, and an image-side surface S4 of the second lens E2 is a concave surface. The third lens E3 has a positive refractive power, an object-side surface S5 of the third lens E3 is a convex surface, and an image-side surface S6 of the third lens E3 is a convex surface. The fourth lens E4 has a positive refractive power, an object-side surface S7 of the fourth lens E4 is a concave surface, and an image-side surface S8 of the fourth lens E4 is a convex surface. The fifth lens E5 has a negative refractive power, an object-side surface S9 of the fifth lens E5 is a convex surface, and an image-side surface S10 of the fifth lens E5 is a concave surface. The sixth lens E6 has a negative refractive power, an object-side surface S11 of the sixth lens E6 is a concave surface, and an image-side surface S12 of the sixth lens E6 is a convex surface. An optical filter is further disposed between the sixth lens E6 and an image plane S15, and the optical filter has an object-side surface S13 (not shown) and an image-side surface S14 (not shown). Light from an object sequentially passes through the surfaces S1-S14, and finally forms an image on the image plane S15 (not shown).

The spacing piece group includes a first spacing piece P1, a first auxiliary spacing piece P1b, a second spacing piece P2, a fourth spacing piece P4, and a fifth spacing piece P5. The first spacing piece P1, the first auxiliary spacing piece P1b, and the second spacing piece P2 are placed in the first lens barrel P01. The fourth spacing piece P4 and the fifth spacing piece P5 are placed in the second lens barrel P02. The spacing pieces can block the entry of excess light to a next lens during imaging, and at the same time, can make the lenses better supported against the first lens barrel P01 and the second lens barrel P02, enhancing the structural stability of the optical imaging lens assembly.

Table 7 is a table showing basic parameters of the optical imaging lens assembly of Embodiment 7. Here, the units of a radius of curvature, a thickness/distance, a focal length and an effective semi-aperture are millimeters (mm).

TABLE 7

| | | | | material | | | effective |
|---|---|---|---|---|---|---|---|
| surface | surface | radius of | | refractive | abbe | focal | semi- |
| number | type | curvature | thickness | index | number | length | aperture |
| OBJ | | infinite | infinite | | | | |
| S1 | aspheric | 8.4591 | 2.7097 | 1.49 | 70.4 | 30.91 | 4.5630 |
| S2 | aspheric | 17.2023 | 0.8718 | | | | 4.3411 |
| S3 | aspheric | 4.4161 | 0.8722 | 1.62 | 25.9 | −14.22 | 4.1764 |
| S4 | aspheric | 2.7193 | 0.6038 | | | | 4.0619 |
| S5 | aspheric | 6.4597 | 3.4000 | 1.54 | 56.11 | 7.74 | 4.1179 |
| S6 | aspheric | −9.9591 | 0.9223 | | | | 3.9349 |
| S7 | aspheric | −11.5145 | 0.7983 | 1.66 | 20.37 | 150.56 | 3.6338 |
| S8 | aspheric | −10.6157 | 0.0837 | | | | 3.5246 |
| S9 | aspheric | 10.9962 | 1.2784 | 1.54 | 56.11 | −29.76 | 3.5042 |
| S10 | aspheric | 6.2881 | 1.7269 | | | | 3.3096 |
| S11 | aspheric | −12.5874 | 1.7912 | 1.54 | 56.11 | −27.02 | 3.3231 |
| S12 | aspheric | −90.2125 | 4.7524 | | | | 4.2870 |
| S13 | | infinite | 0.2100 | 1.52 | 64.2 | | 8.0000 |
| S14 | | infinite | 1.1602 | | | | 8.0000 |
| S15 | | infinite | 0.0000 | | | | 5.87 |

In this embodiment, the value of a total effective focal length f of the optical imaging lens assembly is 18.46 mm. The value of half of a maximal field-of-view Semi-FOV of the optical imaging lens assembly is 17.37°. The value of a combined focal length f123 of the first lens, the second lens and the third lens is 12.27 mm. The value of a combined focal length f456 of the fourth lens, the fifth lens and the sixth lens is −15.33 mm.

In this embodiment, the object-side surface and the image-side surface of any lens in the first to sixth lenses E1-E6 are both aspheric surfaces. Table 8 shows the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 7.

TABLE 8

| surface | | | | | | | |
|---|---|---|---|---|---|---|---|
| number | A4 | A6 | A8 | A10 | A12 | A14 | A16 |
| S1 | 9.3628E−04 | −6.2240E−04 | 2.5256E−04 | −6.0762E−05 | 8.1124E−06 | −3.6759E−07 | −6.6051E−08 |
| S2 | 4.4538E−03 | −3.3752E−03 | 2.0190E−03 | −7.8632E−04 | 2.0655E−04 | −3.8188E−05 | 5.1009E−06 |
| S3 | −3.6028E−03 | −3.4912E−03 | 2.2224E−03 | −8.9437E−04 | 2.4315E−04 | −4.6549E−05 | 6.4580E−06 |
| S4 | −1.0613E−03 | −7.6465E−03 | 5.2749E−03 | −2.3098E−03 | 6.9025E−04 | −1.4539E−04 | 2.2083E−05 |
| S5 | 5.0770E−03 | −5.5672E−03 | 3.3741E−03 | −1.3731E−03 | 3.8911E−04 | −7.9084E−05 | 1.1760E−05 |
| S6 | 3.7922E−04 | −3.6514E−04 | 3.5342E−04 | −2.2705E−04 | 9.8573E−05 | −2.8996E−05 | 5.8972E−06 |
| S7 | 1.1138E−02 | −4.1283E−03 | 2.6722E−03 | −1.4212E−03 | 5.5718E−04 | −1.5931E−04 | 3.3278E−05 |
| S8 | 1.1055E−02 | −1.0290E−02 | 9.4301E−03 | −5.5666E−03 | 2.2817E−03 | −6.7738E−04 | 1.4814E−04 |
| S9 | −9.0391E−03 | −5.4035E−03 | 6.4744E−03 | −3.7620E−03 | 1.4891E−03 | −4.3718E−04 | 9.7710E−05 |
| S10 | −1.1042E−02 | −2.8817E−03 | 4.7961E−03 | −3.4489E−03 | 1.6289E−03 | −5.4434E−04 | 1.3277E−04 |
| S11 | −6.2656E−03 | 2.3564E−03 | −2.2372E−03 | 1.5013E−03 | −7.5421E−04 | 2.8339E−04 | −7.8560E−05 |
| S12 | −1.6685E−03 | −9.2664E−04 | 7.6255E−04 | −3.6829E−04 | 1.1725E−04 | −2.5759E−05 | 4.0195E−06 |
| surface | | | | | | | |
| number | A18 | A20 | A22 | A24 | A26 | A28 | A30 |
| S1 | 1.4712E−08 | −1.4648E−09 | 8.9722E−11 | −3.5636E−12 | 8.9887E−14 | −1.3137E−15 | 8.4935E−18 |
| S2 | −4.9851E−07 | 3.5673E−08 | −1.8479E−09 | 6.7411E−11 | −1.6415E−12 | 2.3936E−14 | −1.5801E−16 |
| S3 | −6.5988E−07 | 4.9843E−08 | −2.7558E−09 | 1.0858E−10 | −2.8886E−12 | 4.6525E−14 | −3.4263E−16 |
| S4 | −2.4498E−06 | 1.9893E−07 | −1.1705E−08 | 4.8603E−10 | −1.3508E−11 | 2.2542E−13 | −1.7073E−15 |
| S5 | −1.2921E−06 | 1.0488E−07 | −6.2117E−09 | 2.6092E−10 | −7.3578E−12 | 1.2478E−13 | −9.6055E−16 |
| S6 | −8.4374E−07 | 8.5580E−08 | −6.1228E−09 | 3.0224E−10 | −9.7989E−12 | 1.8783E−13 | −1.6134E−15 |
| S7 | −5.0818E−06 | 5.6491E−07 | −4.5125E−08 | 2.5206E−09 | −9.3416E−11 | 2.0635E−12 | −2.0561E−14 |
| S8 | −2.3947E−05 | 2.8441E−06 | −2.4434E−07 | 1.4741E−08 | −5.9151E−10 | 1.4161E−11 | −1.5295E−13 |
| S9 | −1.6580E−05 | 2.1011E−06 | −1.9405E−07 | 1.2604E−08 | −5.4349E−10 | 1.3934E−11 | −1.6051E−13 |
| S10 | −2.3924E−05 | 3.1816E−06 | −3.0802E−07 | 2.1078E−08 | −9.6492E−10 | 2.6479E−11 | −3.2904E−13 |
| S11 | 1.5896E−05 | −2.3250E−06 | 2.4215E−07 | −1.7470E−08 | 8.2842E−10 | −2.3201E−11 | 2.9055E−13 |
| S12 | −4.5235E−07 | 3.6836E−08 | −2.1504E−09 | 8.7711E−11 | −2.3729E−12 | 3.8249E−14 | −2.7796E−16 |

### Embodiment 8

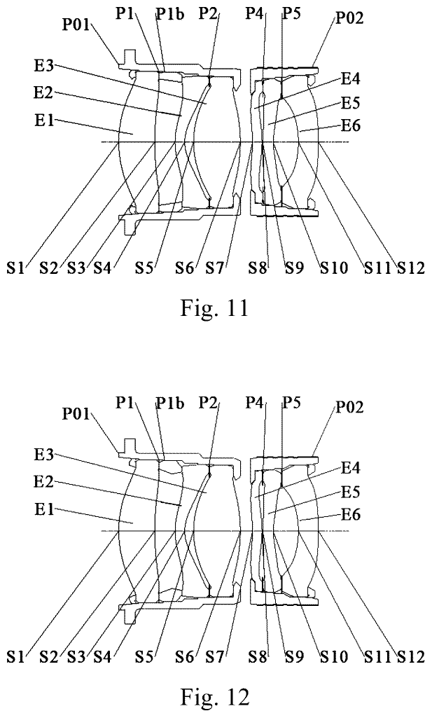

An optical imaging lens assembly according to Embodiment 8 of the present disclosure is described below with reference to FIG. 11.

As shown in FIG. 11, the optical imaging lens assembly includes a lens barrel assembly, an optical lens group and a spacing piece group. The lens barrel assembly includes a first lens barrel P01 and a second lens barrel P02. The structure of the optical lens group is the same as that of the optical lens group in Embodiment 7. The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b, and the second spacing piece P2 are placed in the first lens barrel P01. The fourth spacing piece P4 and the fifth spacing piece P5 are placed in the second lens barrel P02.

The structure of the optical lens group in this embodiment is the same as that of the optical lens group in Embodiment 7, that is, the table of the basic parameters of the optical imaging lens assembly in this embodiment is the same as Table 7, and the table of the coefficients of the aspheric surfaces is the same as Table 8. This embodiment differs from Embodiment 4 in that, the structure sizes of at least some of the first lens barrel P01, the second lens barrel P02, the first spacing piece P1, the first auxiliary spacing piece P1b, the second spacing piece P2, the fourth spacing piece P4 and the fifth spacing piece P5 are different from that of Embodiment 7.

### Embodiment 9

An optical imaging lens assembly according to Embodiment 9 of the present disclosure is described below with reference to FIG. 12.

As shown in FIG. 12, the optical imaging lens assembly includes a lens barrel assembly, an optical lens group and a spacing piece group. The lens barrel assembly includes a first lens barrel P01 and a second lens barrel P02. The structure of the optical lens group is the same as that of the optical lens group in Embodiment 7. The spacing piece group includes a first spacing piece P1, a first auxiliary spacing piece P1b, a second spacing piece P2, a fourth spacing piece P4 and a fifth spacing piece P5. The first spacing piece P1, the first auxiliary spacing piece P1b and the second spacing piece P2 are placed in the first lens barrel P01. The fourth spacing piece P4 and the fifth spacing piece P5 are placed in the second lens barrel P02.

The structure of the optical lens group in this embodiment is the same as that of the optical lens group in Embodiment 7, that is, the table of the basic parameters of the optical imaging lens assembly in this embodiment is the same as Table 7, and the table of the coefficients of the aspheric surfaces is the same as Table 8. This embodiment differs from Embodiment 7 in that, the structure sizes of at least some of the first lens barrel P01, the second lens barrel P02, the first spacing piece P1, the first auxiliary spacing piece P1b, the second spacing piece P2, the fourth spacing piece P4 and the fifth spacing piece P5 are different from that of Embodiment 7.

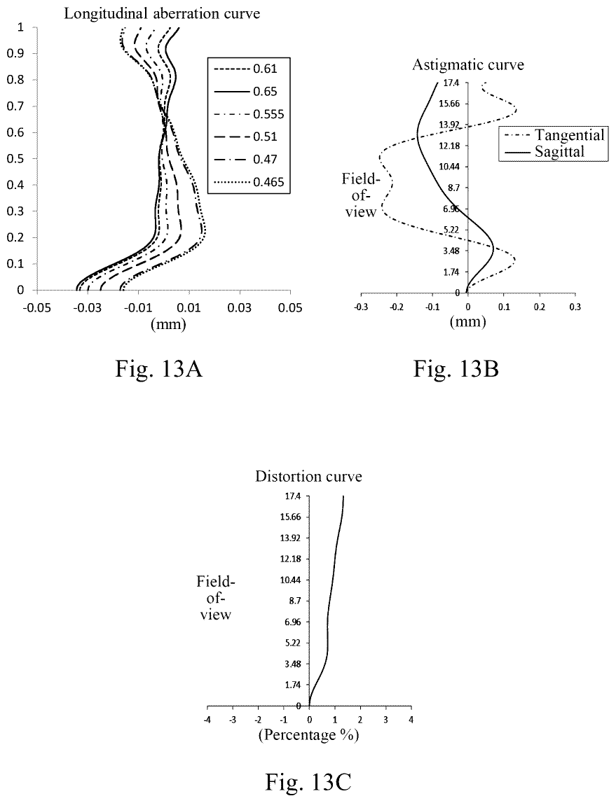

FIG. 13A illustrates a longitudinal aberration curve of the optical imaging lens assemblies of Embodiments 7, 8 and 9, representing deviations of focal points of light of different wavelengths converged after passing through an optical imaging lens assembly. FIG. 13B illustrates an astigmatic curve of the optical imaging lens assemblies of Embodiments 7, 8 and 9, representing curvatures of the tangential image plane and curvatures of the sagittal image plane that correspond to different field-of-views. FIG. 13C illustrates a distortion curve of the optical imaging lens assemblies of Embodiments 7, 8 and 9, representing amounts of distortion corresponding to different fields-of-views. It can be seen from FIGS. 13A-13C that the optical imaging lens assemblies given in Embodiments 7, 8 and 9 can achieve a good imaging quality.

Table 9 shows the values of the parameters such as d1s, D1s, d2s, d2m, d4s, d4m, d5s, d5m, d01s, d01m, d02s, d02m, EP01, CP1, CP1b, EP12, CP4, EP45, CP5, L1, L2, SAG21, SAG22, SAG51 and SAG52 in each of Embodiments 1-9. Here, the above parameters can be measured according to the marking method shown in FIG. 1, and the units of the parameters listed in Table 9 are all mm.

TABLE 9

| | Embodiment | | | | | | | | |
|---|---|---|---|---|---|---|---|---|---|
| Parameter | 1 | 2 | 3 | 4 | 5 | 6 | 7 | 8 | 9 |
| d1s | 8.66 | 8.54 | 8.55 | 9.39 | 9.48 | 9.54 | 9.31 | 9.14 | 9.25 |
| D1s | 10.90 | 10.87 | 11.02 | 10.82 | 11.20 | 11.05 | 11.37 | 10.86 | 10.96 |
| d2s | 8.19 | 8.15 | 8.21 | 8.82 | 8.92 | 8.69 | 8.36 | 8.51 | 8.28 |
| d2m | 8.19 | 8.15 | 8.21 | 8.99 | 9.09 | 9.09 | 8.36 | 8.51 | 8.28 |
| d4s | 7.03 | 6.97 | 7.03 | 7.23 | 7.17 | 7.28 | 6.97 | 6.89 | 7.03 |
| d4m | 7.03 | 6.97 | 7.03 | 7.23 | 7.17 | 7.28 | 6.97 | 6.89 | 7.03 |
| d5s | 6.62 | 6.60 | 6.67 | 6.88 | 6.84 | 6.94 | 6.71 | 6.68 | 6.82 |
| d5m | 6.62 | 6.60 | 6.67 | 6.88 | 6.84 | 6.94 | 6.71 | 6.68 | 6.82 |
| d01s | 11.25 | 11.23 | 11.40 | 11.19 | 11.57 | 11.42 | 11.74 | 11.27 | 11.38 |
| d01m | 8.72 | 8.91 | 8.62 | 8.95 | 8.63 | 8.59 | 8.21 | 8.78 | 8.41 |
| d02s | 7.75 | 7.78 | 7.68 | 7.87 | 8.16 | 7.60 | 7.40 | 7.54 | 7.45 |
| d02m | 10.50 | 10.54 | 10.44 | 10.56 | 10.80 | 10.50 | 10.37 | 10.60 | 10.50 |
| EP01 | 3.28 | 3.28 | 3.28 | 2.83 | 2.83 | 2.83 | 3.17 | 3.17 | 3.17 |
| CP1 | 0.02 | 0.03 | 0.02 | 0.02 | 0.03 | 0.03 | 0.02 | 0.02 | 0.02 |
| CP1b | 1.03 | 1.02 | 1.04 | 1.48 | 1.46 | 1.47 | 1.82 | 1.82 | 1.82 |
| EP12 | 3.00 | 2.99 | 3.01 | 3.45 | 3.44 | 3.44 | 3.77 | 3.77 | 3.77 |
| CP4 | 0.02 | 0.02 | 0.04 | 0.02 | 0.02 | 0.02 | 0.02 | 0.02 | 0.04 |
| EP45 | 1.66 | 1.66 | 1.66 | 1.78 | 1.78 | 1.78 | 1.44 | 1.44 | 1.44 |
| CP5 | 0.02 | 0.02 | 0.02 | 0.02 | 0.02 | 0.02 | 0.02 | 0.03 | 0.03 |
| L1 | 8.47 | 8.47 | 8.47 | 8.63 | 8.63 | 8.63 | 9.62 | 9.62 | 9.62 |
| L2 | 5.91 | 5.91 | 5.91 | 5.91 | 5.91 | 5.91 | 5.35 | 5.35 | 5.35 |
| SAG21 | 0.63 | 0.63 | 0.63 | 0.56 | 0.56 | 0.56 | 0.84 | 0.84 | 0.84 |
| SAG22 | 1.61 | 1.61 | 1.61 | 1.52 | 1.52 | 1.52 | 1.73 | 1.73 | 1.73 |
| SAG51 | 0.18 | 0.18 | 0.18 | 0.05 | 0.05 | 0.05 | 0.07 | 0.07 | 0.07 |
| SAG52 | 0.51 | 0.51 | 0.51 | 0.32 | 0.32 | 0.32 | 0.27 | 0.27 | 0.27 |

Table 10 shows the values of the condition expressions in each of Embodiments 1-9.

TABLE 10

| | Embodiment | | | | | | | | |
|---|---|---|---|---|---|---|---|---|---|
| Conditional expression | 1 | 2 | 3 | 4 | 5 | 6 | 7 | 8 | 9 |
| (d4s + d5s)/f456 | −0.99 | −0.99 | −1.00 | −1.02 | −1.01 | −1.03 | −0.89 | −0.89 | −0.90 |
| CP4/T45 − CP5/T56 | 0.43 | 0.43 | 0.79 | 0.72 | 0.72 | 0.72 | 0.25 | 0.24 | 0.46 |
| d02s/DT41 − d02m/DT62 | −0.13 | −0.13 | −0.13 | −0.13 | −0.12 | −0.16 | −0.19 | −0.20 | −0.20 |
| d01m/R6 − d02s/R7 | 0.17 | 0.16 | 0.17 | −0.09 | −0.03 | −0.08 | −0.18 | −0.23 | −0.20 |
| (d01s − d1s)/f1 × V1 | 6.96 | 7.24 | 7.65 | 5.72 | 6.66 | 5.98 | 5.53 | 4.85 | 4.85 |
| (D1s − d1s)/DT12 | 0.24 | 0.25 | 0.26 | 0.15 | 0.18 | 0.16 | 0.24 | 0.20 | 0.20 |
| (EP01 + EP12)/(f1 + f2) | 0.53 | 0.53 | 0.53 | 0.67 | 0.67 | 0.67 | 0.42 | 0.42 | 0.42 |
| (CP1 + CP1b)/T12 | 0.65 | 0.66 | 0.66 | 1.44 | 1.44 | 1.45 | 2.11 | 2.11 | 2.11 |
| EP12/(SAG21 + SAG22) | 1.34 | 1.34 | 1.34 | 1.66 | 1.66 | 1.66 | 1.47 | 1.47 | 1.47 |
| d2m/DT31 − d2s/DT22 | −0.02 | −0.02 | −0.02 | 0.00 | 0.00 | 0.03 | −0.01 | −0.01 | −0.01 |
| (d4m − d5m)/CT5 × N5 | 0.74 | 0.67 | 0.65 | 0.39 | 0.37 | 0.38 | 0.31 | 0.26 | 0.25 |
| EP45/(SAG51 + SAG52) | 2.42 | 2.42 | 2.42 | 4.78 | 4.78 | 4.78 | 4.29 | 4.29 | 4.29 |
| f123/L1 + f456/L2 | −0.89 | −0.89 | −0.89 | −0.93 | −0.93 | −0.93 | −1.59 | −1.59 | −1.59 |

The present disclosure further provides an imaging apparatus having an electronic photosensitive element which may be a charge coupled device (CCD) or complementary metal-oxide semiconductor element (CMOS). The imaging apparatus may be an independent imaging device such as a digital camera, or may be an imaging module integrated in a mobile electronic device such as a mobile phone. The imaging apparatus is equipped with the optical imaging lens assembly described above.

The foregoing is only a description for the preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical imaging lens assembly, comprising
an optical lens group, comprising a first lens group and a second lens group, the second lens group having a negative refractive power, wherein the first lens group and the second lens group are sequentially arranged along an optical axis from an object side to an image side, the first lens group comprises a first lens, a second lens and a third lens, and the second lens group comprises a fourth lens having a positive refractive power, a fifth lens having a negative refractive power, and a sixth lens having a negative refractive power;
a spacing piece group, comprising a fourth spacing piece placed on an image-side surface of the fourth lens and in contact with the image-side surface of the fourth lens, and a fifth spacing piece placed on an image-side surface of the fifth lens and in contact with the image-side surface of the fifth lens; and
a lens barrel assembly, comprising a first lens barrel and a second lens barrel, wherein the first lens group is placed in the first lens barrel, and the second lens group, the fourth spacing piece and the fifth spacing piece are placed in the second lens barrel,
wherein a number of lenses having refractive powers in the optical imaging lens assembly is six,
a combined focal length f456 of the fourth lens, the fifth lens and the sixth lens, an inner diameter d4s of an object-side surface of the fourth spacing piece, and an inner diameter d5s of an object-side surface of the fifth spacing piece satisfy:
$$- 1.1 < ( d 4 s + d 5 s ) / f 456 < 0 ,$$
and
an air spacing T45 between the fourth lens and the fifth lens on the optical axis, an air spacing T56 between the fifth lens and the sixth lens on the optical axis, a maximal thickness CP4 of the fourth spacing piece, and a maximal thickness CP5 of the fifth spacing piece satisfy: 0.2<CP4/T45−CP5/T56<0.8.

2. The optical imaging lens assembly according to claim 1, wherein an effective aperture DT41 of an object-side surface of the fourth lens, an effective aperture DT62 of an image-side surface of the sixth lens, an inner diameter d02s of an object-side end surface of the second lens barrel, and an inner diameter d02m of an image-side end surface of the second lens barrel satisfy: −0.3<d02s/DT41−d02m/DT62<0.

3. The optical imaging lens assembly according to claim 1, wherein a radius of curvature R6 of an image-side surface of the third lens, a radius of curvature R7 of an object-side surface of the fourth lens, an inner diameter d01m of an image-side end surface of the first lens barrel, and an inner diameter d02s of an object-side end surface of the second lens barrel satisfy: −0.3<d01m/R6−d02s/R7<0.3.

4. The optical imaging lens assembly according to claim 1, wherein a center thickness CT5 of the fifth lens on the optical axis, a refractive index N5 of the fifth lens, an inner diameter d4m of an image-side surface of the fourth spacing piece, and an inner diameter d5m of an image-side surface of the fifth spacing piece satisfy: 0.2<(d4m−d5m)/CT5×N5<0.8.

5. The optical imaging lens assembly according to claim 1, wherein an axial distance SAG51 from an intersection point of an object-side surface of the fifth lens and the optical axis to a projection point of an effective semi-aperture vertex of the object-side surface of the fifth lens onto the optical axis, an axial distance SAG52 from an intersection point of the image-side surface of the fifth lens and the optical axis to a projection point of an effective semi-aperture vertex of the image-side surface of the fifth lens onto the optical axis, and a spacing EP45 between the fourth spacing piece and the fifth spacing piece along the optical axis satisfy:
$$2 < EP 45 / ( SAG 51 + SAG 52 ) < 5 .$$

6. The optical imaging lens assembly according to claim 1, wherein a combined focal length f123 of the first lens, the second lens and the third lens, the combined focal length f456 of the fourth lens, the fifth lens and the sixth lens, a length L1 of the first lens barrel along a direction of the optical axis, and a length L2 of the second lens barrel along the direction of the optical axis satisfy: −2<f123/L1+f456/L2<−0.8.

7. The optical imaging lens assembly according to claim 1, wherein the spacing piece group further comprises a first spacing piece placed on an image-side surface of the first lens and in contact with the image-side surface of the first lens, and
an effective focal length f1 of the first lens, an abbe number V1 of the first lens, an inner diameter d01s of an object-side end surface of the first lens barrel, and an inner diameter d1s of an object-side surface of the first spacing piece satisfy:
$$4 < ( d 01 s - d 1 s ) / f 1 \times V 1 < 8.$$

8. The optical imaging lens assembly according to claim 1, wherein the spacing piece group further comprises a first spacing piece placed on an image-side surface of the first lens and in contact with the image-side surface of the first lens, and
an effective aperture DT12 of the image-side surface of the first lens, an inner diameter d1s of an object-side surface of the first spacing piece, and an outer diameter D1s of the object-side surface of the first spacing piece satisfy:
$$0 < ( D 1 s - d 1 s ) / DT 12 < 0.3 .$$

9. The optical imaging lens assembly according to claim 1, wherein the spacing piece group further comprises a first spacing piece and a first auxiliary spacing piece, wherein the first spacing piece is placed on an image-side surface of the first lens and in contact with the image-side surface of the first lens, and the first auxiliary spacing piece is placed on an image-side surface of the first spacing piece and in contact with the image-side surface of the first spacing piece, and
an air spacing T12 between the first lens and the second lens on the optical axis, a maximal thickness CP1 of the first spacing piece, and a maximal thickness CP1b of the first auxiliary spacing piece satisfy: 0.5<(CP1+CP1b)/T12<2.5.

10. The optical imaging lens assembly according to claim 1, wherein the spacing piece group further comprises a second spacing piece, the second spacing piece is placed on an image-side surface of the second lens and in contact with the image-side surface of the second lens, and
an effective aperture DT22 of the image-side surface of the second lens, an effective aperture DT31 of an object-side surface of the third lens, an inner diameter d2s of an object-side surface of the second spacing piece, and an inner diameter d2m of an image-side surface of the second spacing piece satisfy:
$$- 0.1 < d 2 m / DT 31 - d 2 s / DT 22 < 0.1 .$$

11. The optical imaging lens assembly according to claim 1, wherein the spacing piece group further comprises a first spacing piece and a second spacing piece, the first spacing piece is placed on an image-side surface of the first lens and in contact with the image-side surface of the first lens, and the second spacing piece is placed on an image-side surface of the second lens and in contact with the image-side surface of the second lens, and
an axial distance SAG21 from an intersection point of an object-side surface of the second lens and the optical axis to a projection point of an effective semi-aperture vertex of the object-side surface of the second lens onto the optical axis, an axial distance SAG22 from an intersection point of the image-side surface of the second lens and the optical axis to a projection point of an effective semi-aperture vertex of the image-side surface of the second lens onto the optical axis, and a spacing EP12 between the first spacing piece and the second spacing piece along the optical axis satisfy: 1<EP12/(SAG21+SAG22)<2.

12. The optical imaging lens assembly according to claim 1, wherein the spacing piece group further comprises a first spacing piece and a second spacing piece, the first spacing piece is placed on an image-side surface of the first lens and in contact with the image-side surface of the first lens, and the second spacing piece is placed on an image-side surface of the second lens and in contact with the image-side surface of the second lens, and
a spacing EP01 between an object-side end surface of the first lens barrel and the first spacing piece along the optical axis, a spacing EP12 between the first spacing piece and the second spacing piece along the optical axis, an effective focal length f1 of the first lens, and an effective focal length f2 of the second lens satisfy:
$$- 0.4 < ( E P 01 + E P 12 ) / ( f 1 + f 2 ) < 0.8 .$$
